(19) United States
(12) Patent Application Publication
(10) Pub. No.: US 2004/0250280 A1
(43) Pub. Date: Dec. 9, 2004

(54) SYSTEM AND METHOD FOR INTERACTING WITH EPG GRID USING STABLE UNDERLYING FOCAL POINT

(75) Inventor: David E. Allport, Palo Alto, CA (US)

Correspondence Address: DISCOVISION ASSOCIATES, INTELLECTUAL PROPERTY DEVELOPMENT, 2355 MAIN STREET, SUITE 200, IRVINE, CA, 92614, US

(73) Assignee: RESEARCH INVESTMENT NETWORK, INC., Irvine, CA (US)

(21) Appl. No.: 10/250,150

(22) Filed: Jun. 6, 2003

(51) Int. Cl. H04N 5/445; G06F 3/00; G06F 13/00

(52) U.S. Cl. 725/56; 725/39

(57) ABSTRACT

An electronic program guide system has a grid displayed on a display area. The grid has horizontal and vertical axes. The grid includes a plurality of cells. Each cell contains information of a program. Means to visually indicate one action cell contained within the grid. An underlying focal point located at a constant stable point in relation to the horizontal and vertical axes. At least one portion of the active cell corresponds to the underlying focal point.

### CROSS REFERENCE TO RELATED APPLICATIONS

This application contains subject matter related to co-pending U.S. patent application Ser. No. 10/065,075, entitled Point-Based System and Method For Interacting with Electronic Program Guide Grid, filed Sep. 13, 2002 and U.S. patent application Ser. No. 10/065,889, entitled Grid-Based System and Method For Interacting with Electronic Program Guide Grid, filed Nov. 27, 2002, both invented by the same inventor as the present invention, and are assigned to the same assignee as the present invention. The entire original disclosure of said co-pending applications is herein expressly incorporated by reference.

### BACKGROUND OF INVENTION

1. Field of the Invention

The present invention relates generally to methods of interacting with displayed data, and more particularly to methods of interacting with electronic program guide (EPG) data displayed in a grid format.

2. Background of Invention

In the EPG systems of the prior art there is typically one “active” program in the grid, and supplementary program information for this program is displayed in a separate area of the display. Two different types of motion are controlled by the user's navigation commands. The first type of motion is motion of the active program indicator with respect to the EPG data. This motion includes horizontal repositioning of the graphical element which identifies the active program to indicate a different program on the same channel, or, in the case of category-based EPG grids, a different program in the same category. This first type of motion also includes vertical repositioning to a program on a different channel, or, in the case of category-based EPG grids, to a program in a different category. The second type of motion is motion of the visible window onto the EPG data. This includes moving horizontally to select an earlier or later displayed time period for the grid, in order to show an earlier or later set of programs on the same set of channels (or categories). It also includes moving vertically to show a set of programs at the same times on a different set of channels (or categories). Motion of the active program indicator with respect to the EPG data takes the form of movements of widely varying amounts in various prior art systems. However, it is typical for EPG systems to restrict motion of the visible window onto the EPG data to multiples of 30 minutes, so that the beginning of the grid's displayed period always aligns with an hour or half-hour boundary.

The co-pending application “Grid-based System and Method For Interacting with Electronic Program Guide Grid” has disclosed a means of solving the problems of non-commutativity of horizontal and vertical motion, which cause navigational difficulties in other prior-art EPG systems. Another source of navigational difficulty for EPG systems is the asymmetries in left-right motion, such that if the user issues a “move left” command followed by a “move right” command (or vice versa), the state that the system ends up in will not necessarily be the same as the state it started in. The grid-based system and method enables most of these asymmetries to be eliminated, but some asymmetries, in particular asymmetries in the position of the visible window, still remain with the grid-based approach. These are an inevitable consequence of the prior art approach of employing a singe set of user commands (e.g. “move up”, “move down”, “move left”, “move right”) to control two the different types of motion noted previously. The presence of these asymmetries can cause user confusion, when the user begins by issuing a command to move in one direction, and immediately follows with a command to move in the opposite direction, and then finds that the grid displayed time period in the final state is different from the grid displayed time period in the initial state

In prior art systems the active program indicator moves to a variety of different positions as a result of motion within a particular displayed grid. When the visible window also moves it may be the case that as a result of issuing a “move right” command, the active program indicator moves to a new position which is to the left of its previous position, in terms of its grid coordinates, even though these coordinates represent a program at a time which is later than the previously active program. Similar effects may occur when the user issues commands to move left, right, up or down. An example is shown in the figures wherein a “move up” command is issued from a system state as shown in FIG. 2A, and the system responds by moving to a state as shown in FIG. 2B. In the initial state of FIG. 2A, the active program indicator is at the top of the grid, highlighting a program at 4.30 pm on channel 67. In the final state of FIG. 2B, the active program indicator is at the bottom of the grid, highlighting a program on channel 66. Thus this response to a “move up” command has scrolled the visible window “up” to display the set of channels from 58 to 66, but the active program has actually moved down in terms of its basic grid coordinates. These complex combinations of motion place an additional cognitive burden upon the user in orienting himself or herself while navigating around the grid.

There is therefore a need for a system, which provides improved EPG grid navigation, without the drawbacks found in prior art systems. The present invention satisfies these needs, as well as others, and overcomes the deficiencies found in existing systems.

### SUMMARY OF INVENTION

The present invention simplifies EPG grid navigation by providing a uniform treatment of both visible window motions with respect to the EPG data, and motion of the active program indicator with respect to the EPG data, such that in response to each navigational user input, these motions are consistently of the same amount in the same direction. This system provides an underlying stable focal point, which remains in the same position with respect to the axes of the displayed grid throughout all navigational movements through the EPG data. In any displayed grid, in the horizontal dimension, at least one part of the cell containing the grid's active program coincides with the point in time corresponding to the horizontal position of the underlying stable focal point. Similarly, in any displayed grid, in the vertical dimension, at least one part of the cell containing the grid's active program coincides with the vertical position of the underlying stable focal point.

The grid's displayed time period is not required to begin or end on an hour or half-hour boundary, but may start and end at any point in time. However, novel horizontal navigation methods together with novel methods for graphically indicating the active program are herein disclosed. For typical EPG data, the result of horizontal motion using these methods will be to align the grid's displayed period with an hour or half-hour boundary, even when program durations are not multiples of 30 minutes, and program start times are not so aligned. Methods are herein disclosed whereby the system provides complete symmetry of horizontal motion. Methods are also disclosed whereby the system provides improved navigational efficiency in traversing typical EPG data containing both very short programs (e.g. 15 minutes or less) and very long programs (e.g. 90 minutes or more).

According to a first embodiment of the invention, one type of visual indication of the active program is used consistently throughout EPG grid navigation. According to a second embodiment, three different types of visual indication are used, depending upon whether the underlying focal point lies at the beginning, end, or somewhere in the middle of the active cell's horizontal extent.

### BRIEF DESCRIPTION OF DRAWINGS

FIG. 1A is a block diagram illustrating one embodiment of an entertainment system in accordance with the teachings of the present invention.

FIG. 1B is a block diagram illustrating one embodiment of a computer system in accordance with the teachings of the present invention.

FIG. 2A is a diagrammatic representation of an EPG according to the prior art.

FIG. 2B is a diagrammatic representation of an EPG, illustrating a possible result of a “move up” command from an initial state as in FIG. 1 according to the prior art.

FIG. 3 is a diagrammatic representation of an EPG according to the present invention.

FIG. 4 is a diagrammatic representation of another EPG according to the present invention.

FIG. 5 is a diagrammatic representation of another EPG according to the present invention.

FIG. 6 is a diagrammatic representation of yet another EPG according to the present invention.

FIG. 7 is a diagrammatic representation of still yet another EPG according to the present invention.

FIG. 8 is a flowchart describing how the system responds to navigation commands, as seen from a user's perspective.

FIG. 9 is a diagrammatic representation of an EPG, wherein the data illustrates a possible result of a “move up” command from an initial state as in FIG. 7 according to the present invention.

FIG. 10 is a diagrammatic representation of an EPG, wherein the data illustrates a possible result of a “move down” command from an initial state as in FIG. 7 according to the present invention.

FIG. 11 is a diagrammatic representation of an EPG, wherein the data illustrates a possible result of a “move right” command from an initial state as in FIG. 7 according to the present invention.

FIG. 12 is a diagrammatic representation of an EPG, wherein the data illustrates a possible result of a “move left” command from an initial state as in FIG. 7 according to the present invention.

FIG. 13 is a flowchart describing how the system responds to a “move up” command, as seen from a system implementation perspective.

FIG. 14 is a flowchart describing how the system responds to a “move up” command, as seen from a system implementation perspective.

FIG. 15 is a flowchart describing how the system responds to a “move right” command, as seen from a system implementation perspective.

FIG. 16 is a diagrammatic representation of an EPG according to the present invention.

FIG. 17 is a diagrammatic representation of an EPG, wherein the data illustrates a possible result of a “move right” command from an initial state as in FIG. 16, according to the present invention.

FIG. 18 is a diagrammatic representation of another EPG according to the present invention.

FIG. 19 is a diagrammatic representation of an EPG, wherein the data illustrates a possible result of a “move right” command from an initial state as in FIG. 18, according to the present invention.

FIG. 20 is a diagrammatic representation of another EPG according to the present invention.

FIG. 21 is a diagrammatic representation of an EPG, wherein the data illustrates a possible result of a “move right” command from an initial state as in FIG. 20, according to the present invention.

FIG. 22 is a diagrammatic representation of another EPG according to the present invention.

FIG. 23 is a diagrammatic representation of an EPG, wherein the data illustrates a possible result of a “move right” command from an initial state as in FIG. 22, according to the present invention.

FIG. 24 is a diagrammatic representation of an EPG, wherein the data illustrates a possible result of a “move right” command from an initial state as in FIG. 21, according to the present invention.

FIG. 25 is a flowchart describing how the system responds to a “move left” command, as seen from a system implementation perspective.

FIG. 26 is a diagrammatic representation of another EPG according to the present invention.

FIG. 27 is a diagrammatic representation of an EPG, wherein the data illustrates a possible result of a “move left” command from an initial state as in FIG. 26, according to the present invention.

FIG. 28 is a diagrammatic representation of an EPG, wherein the data illustrates an initial state from which a “move left” command may result in a state as in FIG. 11, according to the present invention.

FIG. 29 is a diagrammatic representation of another EPG according to the present invention.

FIG. 30 is a diagrammatic representation of an EPG, wherein the data illustrates a possible result of a “move right” command from an initial state as in FIG. 29, according to the present invention, and also illustrates a possible initial state from which a “move left” command may result in the state of FIG. 29.

FIG. 31 is a diagrammatic representation of another EPG according to the present invention.

FIG. 32 is a diagrammatic representation of an EPG, wherein the data illustrates a possible result of a “move right” command from an initial state as in FIG. 31, according to the present invention, and also illustrates a possible initial state from which a “move left” command may result in the state of FIG. 31.

FIG. 33 is a diagrammatic representation of another EPG according to the present invention

FIG. 34 is a diagrammatic representation of an EPG, wherein the data illustrates a possible result of a “move left” command from an initial state as in FIG. 33, according to the present invention.

FIG. 35 is a diagrammatic representation of another EPG according to the present invention.

FIG. 36 is a diagrammatic representation of an EPG, wherein the data illustrates a possible result of a “move right” command from an initial state as in FIG. 35, according to the present invention.

FIG. 37 is a diagrammatic representation of an EPG, wherein the data illustrates a possible result of a move right command from an initial state as in FIG. 36, according to the present invention.

FIG. 38 is a diagrammatic representation of an EPG, wherein the data illustrates a possible result of a “move right” command from an initial state as in FIG. 37, according to the present invention.

FIG. 39 is a diagrammatic representation of an EPG, according to the present invention.

FIG. 40 is a diagrammatic representation of an EPG, wherein the data illustrates a possible result of a “move right” command from an initial state as in FIG. 39, according to the present invention.

FIG. 41 is a diagrammatic representation of an EPG, according to the second embodiment of the present invention.

FIG. 42 is a diagrammatic representation of an EPG, wherein the data illustrates a possible result of a “move right” command from an initial state as in FIG. 41, according to the second embodiment of the present invention.

FIG. 43 is a diagrammatic representation of an EPG, wherein the data illustrates a possible result of a “move up” command from an initial state as in FIG. 42, according to the second embodiment of the present invention.

FIG. 44 is a diagrammatic representation of an EPG, according to the second embodiment of the present invention.

FIG. 45 is a diagrammatic representation of an EPG, wherein the data illustrates a possible result of a “move right” command from an initial state as in FIG. 44, and also illustrates a possible initial state from which a move left command may result in the state of FIG. 44.

FIG. 46 is a flowchart describing how the system responds to navigation commands, according to the second embodiment of the present invention.

### DETAILED DESCRIPTION

In the following description, numerous specific details are set forth. However, it is understood that embodiments of the invention may be practiced without these specific details. In other instances, well-known circuits, structures, and techniques have not been shown in order not to obscure the understanding of this description.

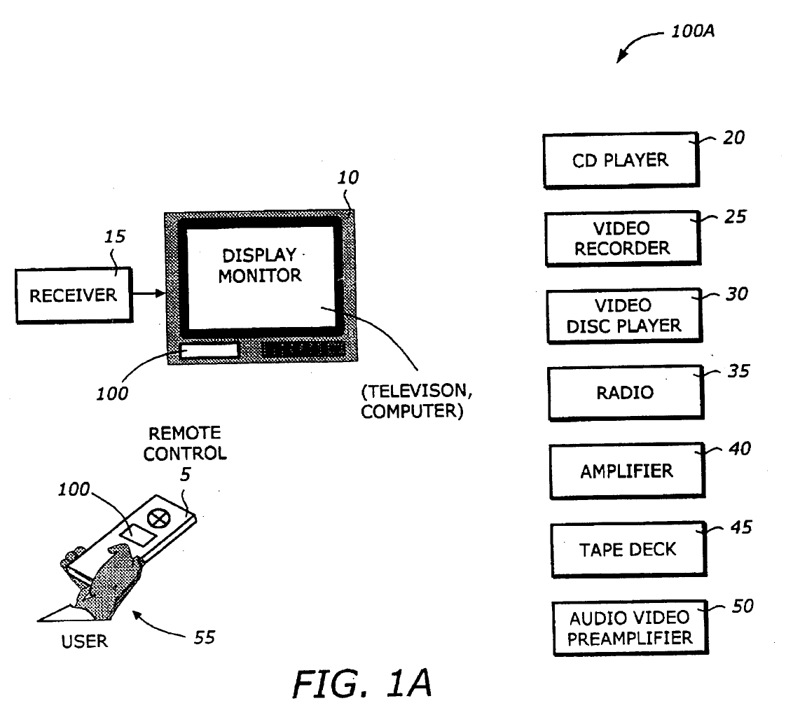

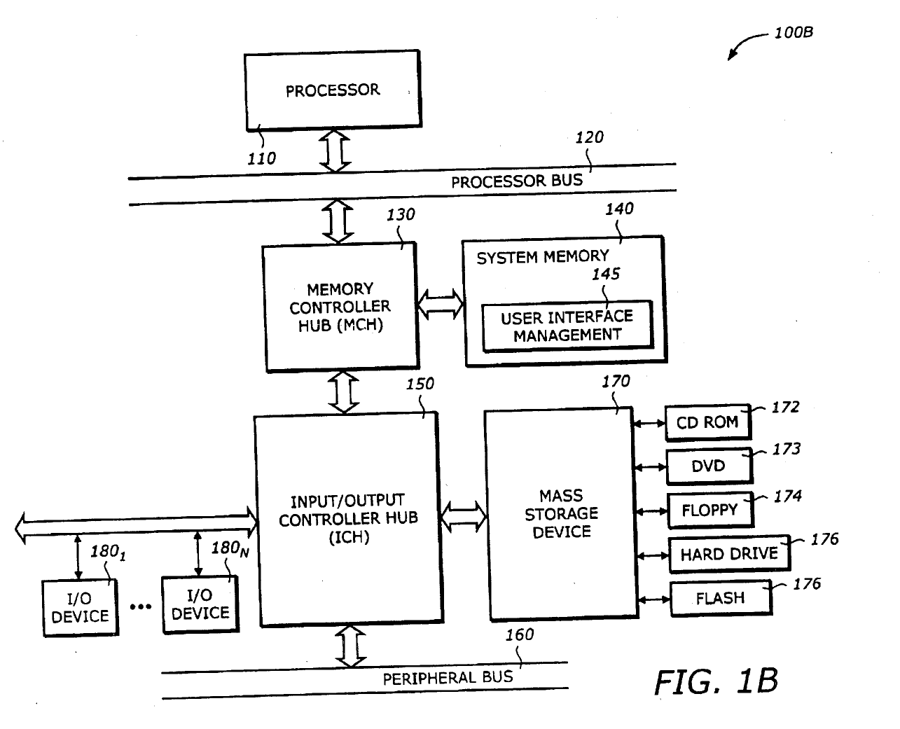

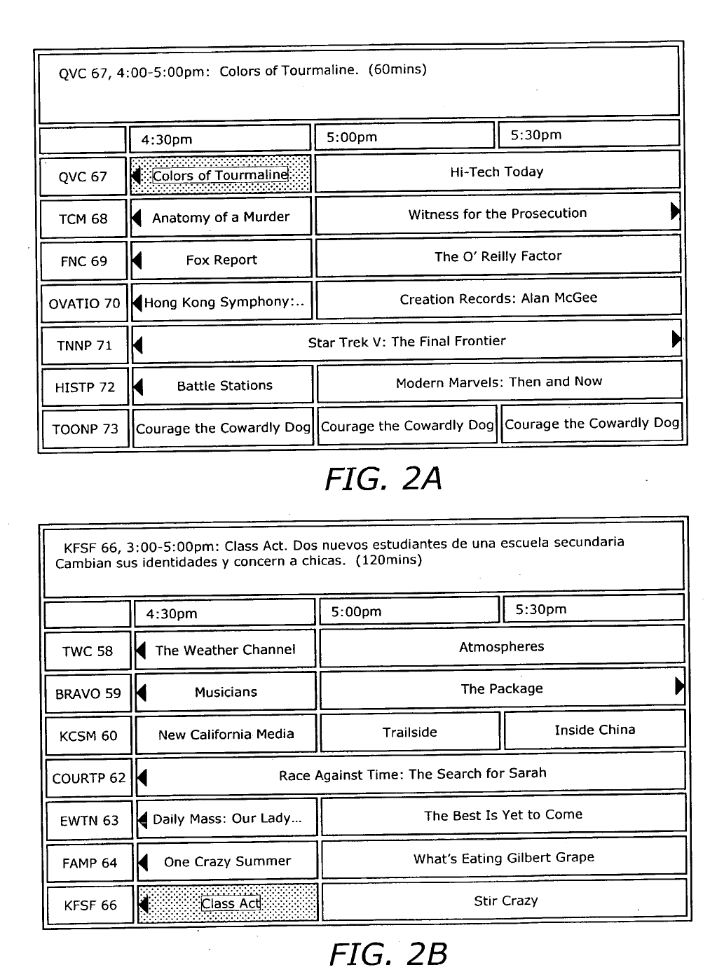

FIG. 1A is a diagram illustrating an entertainment system 100A in which one embodiment of the invention can be practiced. The entertainment system 100A includes a remote controller 5, a television 10, a receiver 15 (e.g., DSS or satellite receiver), a compact disk (CD) player 20, a video recorder 25, a video disc player 30, a radio/a radio tuner 35, an amplifier 40, a tape deck 45, an audio video preamplifier 50 or any combination thereof. The receiver 15 may be a stand-alone unit or may be embedded inside the television 10. The remote controller 5 is adapted for use with a variety of electronic device. The user 55 uses the remote controller 5 to control these electronic devices in the entertainment system 100A. The remote controller 5 may take many forms, such as stand-alone unit, or part of a communication device. The remote controller 5 may be a handheld device that includes a screen to display information, a wireless keyboard, and wireless pointing devices for controlling the electronic devices. The communication between devices in the entertainment system 100A may be via cable (e.g., video, infrared IR, serial, etc.) or wireless technology. It is contemplated that the remote controller 5 may be used with any system adapted to transmit, receive, or process remote controller messages in response to a user input. The television 10 may be an analog television set, or a digital television set, or a computer having television receiver components, etc.

FIG. 1B is a diagram illustrating a processor system 100B in which one embodiment of the invention can be practiced. The processor system 100 includes a processor 110, a processor bus 120, a memory control hub (MCH) 130, a system memory 140, an input/output control hub (ICH) 150, a peripheral bus 155, a mass storage device 170, and input/output devices 180₁ to 180_{K}. Note that the processor system 100 may include more or less elements than these elements. The processor system 100 or a much less scaled version of it is contained in a receiver (i.e., TV, computer, etc.) or a remote controller 5, or any combination thereof. It is noted that the remote controller may be radio or Bluetooth device, or laser, etc.

The processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The processor bus 120 provides interface signals to allow the processor 110 to communicate with other processors or devices, e.g., the MCH 130. The processor bus 120 may support a uni-processor or multiprocessor configuration. The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system 140 may also include peripheral buses such as Peripheral Component Interconnect (PCI), accelerated graphics port (AGP), Industry Standard Architecture (ISA) bus, and Universal Serial Bus (USB), etc.

The system memory 140 stores system code and data. The system memory 140 is typically implemented with dynamic random access memory (DRAM) or static random access memory (SRAM). The system memory 140 may include program code or code segments implementing one embodiment of the invention. The system memory includes a user interface management 145. Any one of the elements of the user interface management 145 may be implemented by hardware, software, firmware, microcode, or any combination thereof. The system memory 140 may also include other programs or data, which are not shown, such as an operating system. The user interface management 145 contains program code that, when executed by the processor 110, causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disc (DVD) 173, floppy drive 174, hard drive 176, flash memory 178, and any other magnetic or optic storage devices. The mass storage device 170 provides a mechanism to read machine-accessible media. The machine-accessible media may contain computer readable program code to perform tasks as described in the following.

The I/O devices 180₁ to 180_{K} may include any I/O devices to perform I/O functions. Examples of I/O devices 180₁ to 180_{K} include controller for input devices (e.g., keyboard, mouse, trackball, pointing device), media card (e.g., audio, video, graphics), network card, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc that is implemented or embodied in a hardware structure (e.g., flash memory, ROM, EROM). Examples of firmware may include microcode, writable control store, and micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or machine readable or accessible medium may include any medium that can store, transmit, or transfer information. Examples of the processor readable or machine accessible medium include an electronic circuit, a semiconductor memory device, a read only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described in the following. The term data here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

The EPG navigation technique in the present invention uses a stable underlying focal point or a focal marker as the basis of navigation. The underlying focal point may be indicated by a visual element. However, the stable underlying focal point is not necessarily indicated by a visible graphical element in the EPG. Each different embodiment of the invention may choose a different location on the grid's x and y axis for the stable underlying focal point, although in a given implementation, its position will normally not move. According a first aspect of the present invention, the position chosen for the underlying focal point corresponds to some point that lies either on a boundary of the active program cell, or within the active program cell, for each EPG grid displayed by the system.

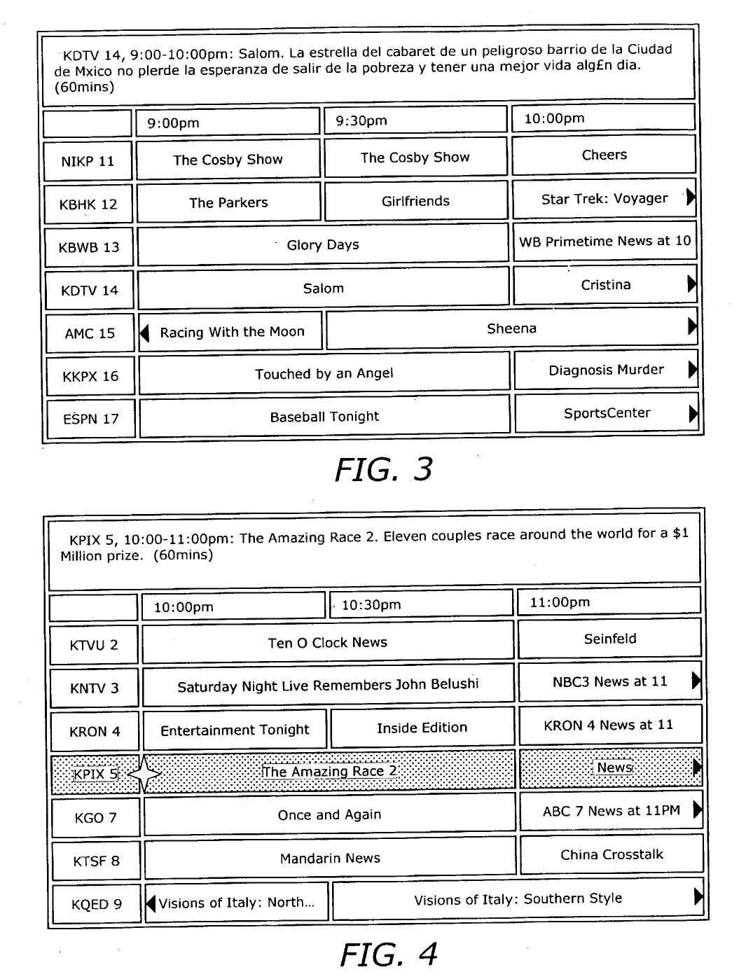

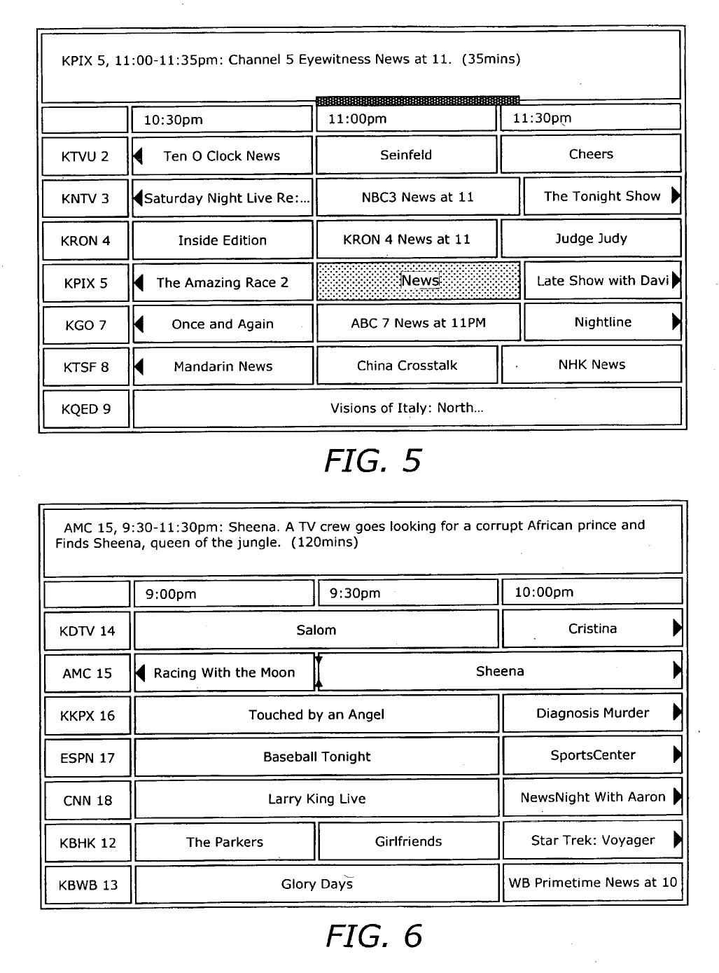

Any method of visually indicating the active program in the grid is compatible with the present invention. Any of the variety of known methods may be employed, as well as new methods disclosed herein and elsewhere. For example, FIG. 3 shows an EPG according to the present invention, wherein the active program is indicated by an information line with a distinguished segment on the active grid row. In this example, the stable underlying focal point lies at grid coordinates approximately one third of the way along the horizontal axis and half way up the vertical axis. In an alternative embodiment, shown in FIG. 4, the active program is indicated by a graphical icon, and the entire active grid row is highlighted. In this embodiment, the stable underlying point lies at a position corresponding to the center of the icon indicating the active program. In yet another embodiment, shown in FIG. 5, the active program is indicated by a two-dimensional cell highlight, and position of the stable underlying focal point lies approximately one third of the way along the grid's horizontal axis and approximately half way up the vertical axis. In still another embodiment, shown in FIG. 6, multiple graphical elements indicate the active program. In this embodiment, the stable underlying focal point lies in the second row from the top of the grid, approximately one-third of the way along the horizontal axis.

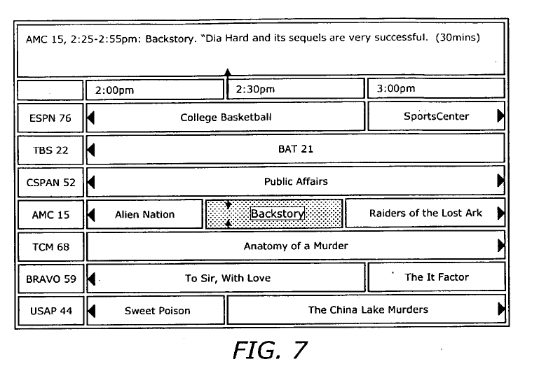

In yet another embodiment, shown in FIG. 7, the active program is indicated both by graphical elements designating an active point in time, and also by two-dimensional cell highlighting. In this embodiment, which is used in the following description of EPG navigation according to the present invention, the stable underlying focal point lies at a position approximately halfway up the vertical axis and one third of the way along the horizontal axis. In this example arrangement, this means that the active grid row is always the fourth row, and the stable underlying focal point lies at a position corresponding to a time 30 minutes later than the beginning of the grid's displayed period.

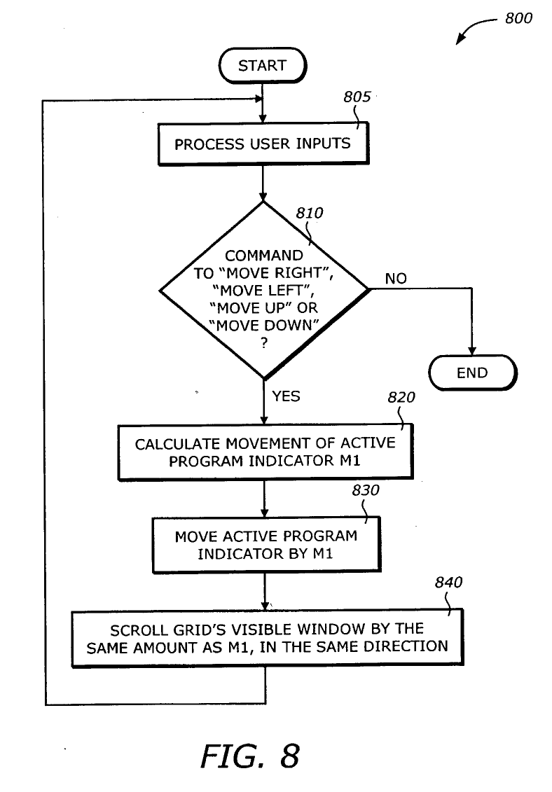

Turning now to FIG. 8, this flowchart 800 illustrates the general method for responding to navigation commands according to the present invention, from the perspective of how a user typically perceives the system behavior. In response to each user command (Block 810), the system calculates a movement of the active program indicator M1 (Block 820), and moves it by M1 accordingly (Block 830). It also moves the visible window by an equal amount as M1 in the same direction, thereby leaving the stable underlying focal point in exactly the same position as before (840), relative to the axes of the displayed grid.

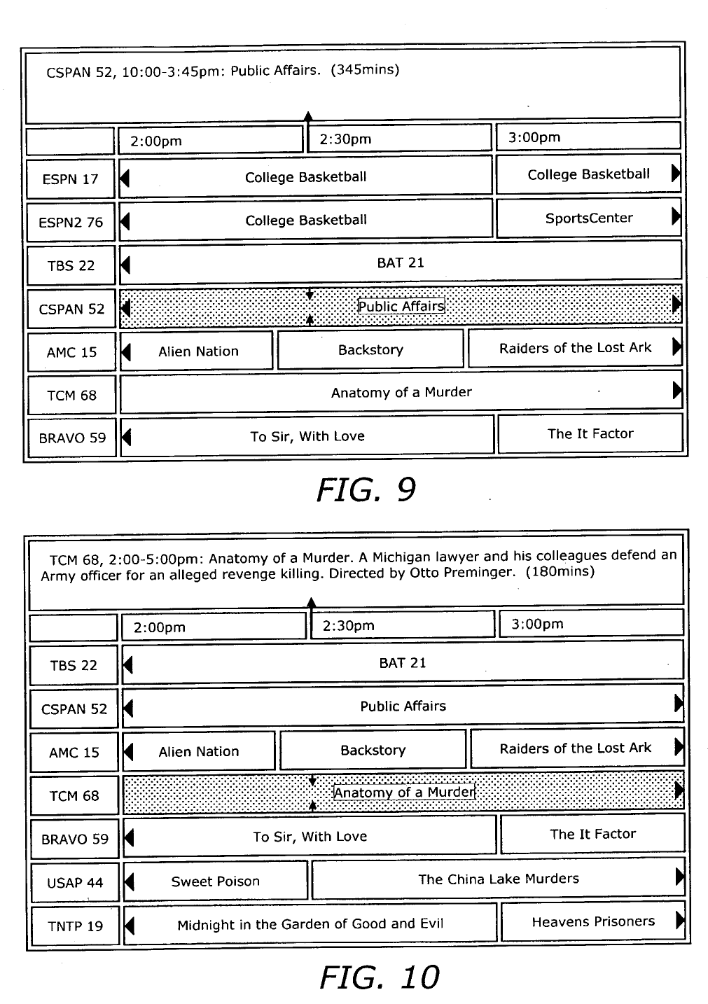

Turning now to FIG. 9, we see an example result of how a system according to the present invention may respond to a “move up” command starting from an initial state as shown in FIG. 7, according to the method shown in FIG. 8. The indicator of the active program has moved up by one grid row, to a position on the line CSPAN 52, and the active program is now “Public Affairs”, with the active point in time still at 2.30 pm. In response to the same command, the visible window has scrolled up by one grid row, and so the underlying focal point remains in the same relative position as before along the displayed axes of the grid.

Turning now to FIG. 10, we see an example result of how a system according to the present invention may respond to a “move down” command starting from an initial state as shown in FIG. 7, according to the method shown in FIG. 8. The indicator of the active program has moved down by one grid row, to a position on the line TCM 68, and the active program is now “Anatomy of a Murder”, with the active point in time still at 2.30 pm. In response to the same command, the visible window has scrolled down by one grid row, and the underlying focal point remains in the same relative position as before along the displayed axes of the grid.

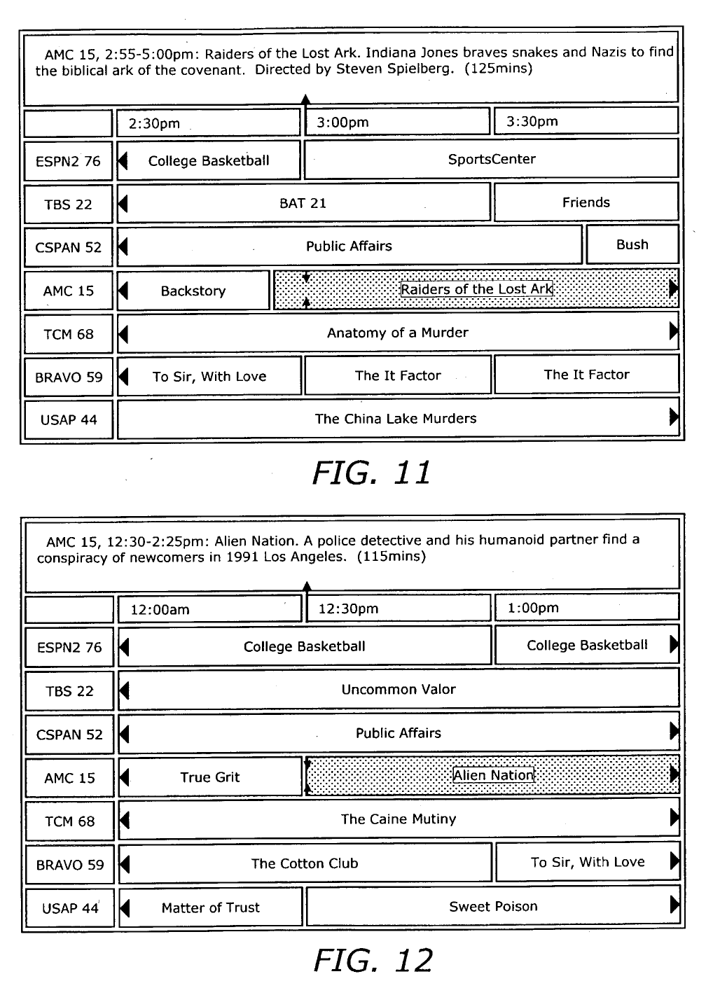

Turning now to FIG. 11, we see an example result of how a system according to the present invention may respond to a “move right” command starting from an initial state as shown in FIG. 7, according to the method shown in FIG. 8. The indicator of the active program has moved right by an amount corresponding to 30 minutes along the horizontal axis, to a position corresponding to 3.00 pm, and the active program is now “Raiders of the Lost Ark”, with the active grid row still being AMC 15. In response to the same command, the visible window has scrolled right by 30 minutes to give a new grid displayed period of 2.30 to 4.00 pm, and again the underlying focal point remains in the same relative position along the displayed axes of the grid.

Turning now to FIG. 12, we see an example result of how a system according to the present invention may respond to a “move left” command starting from an initial state as shown in FIG. 7, according to the method shown in FIG. 8. The indicator of the active program has moved left by an amount corresponding to 120 minutes along the horizontal axis, to a position corresponding to 12.30 pm, and the active program is now “Alien Nation”, with the active grid row still being AMC 15. In response to the same command, the visible window has scrolled left by 120 minutes to give a new grid displayed period of 12.00 to 1.30 pm, and the underlying focal point again remains in the same relative position along the displayed axes of the grid.

The preceding description of FIGS. 7 through 12 is given from the perspective of a user of the system, using the intuitively straightforward metaphor of moving a visible window and an indicator of an active program over a large and unmoving set of EPG data. However, from the perspective of a system designer, an equivalent description of the same system behavior is as follows. There is an unmoving display window with an underlying focal point, which also does not move, and in response to user navigation commands, different subsets of the EPG data are allocated to grid cells displayed in the display window. From the system implementation perspective it is the data that “moves” through the window, and not vice versa.

Therefore the overall navigational method of the invention may be more precisely stated as follows. The system displays a two-dimensional program grid, showing times and durations of programs, wherein the typical arrangement has time on the horizontal axis, with earlier times towards the left and later times towards the right. A grid corresponds to a subset of the EPG data within the electronic guide system. A grid contains plurality of cells, each cell corresponds to a program segment. There may be labels along the horizontal axis denoting each half hour boundary, in order to facilitate the user's associating the program information shown in the grid cells with particular times of day. However, these labels do not designate “columns” as in a regular grid format, since the horizontal boundaries of the program cells on different rows of the grid do not necessarily align with each other to form regular columns. In response to user navigation commands, cells in the grid are repositioned and/or resized, new cells may be added, and some cells may be removed from the grid. Each cell normally has associated with it information for a program, although some cells may have no such information, for example cells in some rows at times in the early hours of the morning when some stations do not broadcast-any programs. Cells are herein described as appearing in “truncated form” when their horizontal dimension in the displayed grid corresponds to a time that is shorter than the associated program's duration, either because the program's start time occurs before the beginning of the grid's displayed period, or because the program's end time occurs after the end of the grid's displayed period, or both. The occurrence of such truncation may in some embodiments be indicated graphically, e.g. by arrows, icons, or other means.

In this typical arrangement, the vertical axis represents program groupings, which we define as programs from the EPG data, which the system allocates to groups with particular shared characteristics. For example, in some embodiments the EPG data may be grouped by channel, and so each row of the program grid will represent a program grouping comprising programs that air at different times on a particular channel. Another example in some embodiments occurs when the system groups the EPG data by category, and so each row of the grid will represent a program grouping comprising programs that air at different times with a particular type of content (e.g., comedy, drama, sports, etc). The order in which the program groupings are displayed may be changed by the system, but during normal grid navigation the groupings are assigned to an order, which does not change (for example, they may appear in numerical order of channel, alphabetical order of station name, user's favorite order, order of content type, etc.). The order will typically start at the top of the grid and proceed down the vertical axis, and when the last grouping is reached the order will “wrap around” to the beginning again.

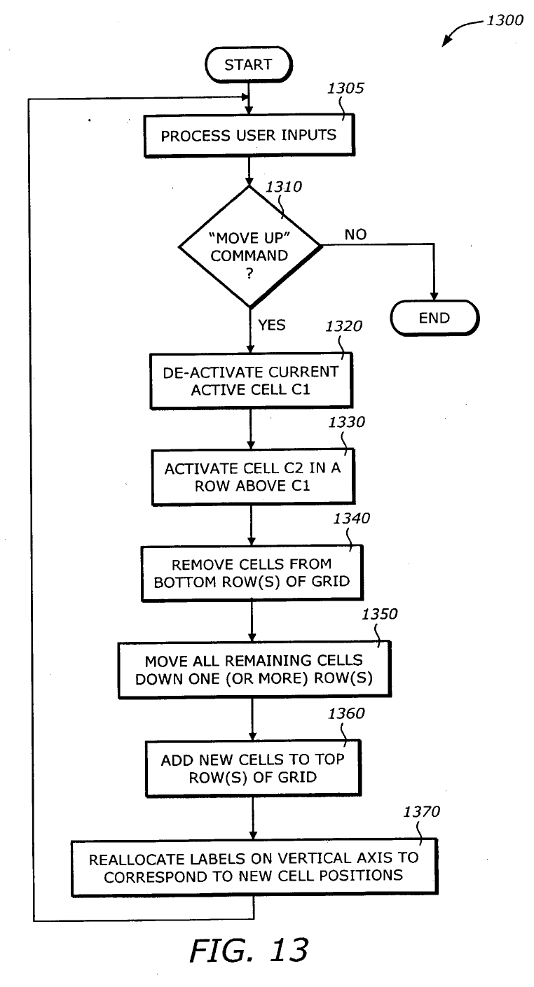

Accordingly, process 1300 as shown FIG. 13 provides a more detailed description of the method for responding to a “move up” command. In embodiments of the invention such as shown in FIGS. 7 and 9, the system moves one row at a time in response to “move up” commands (Block 1310), and the procedure is as follows. The system “de-activates” the currently active program cell C1 (Block 1320), and makes a new cell C2 active in the row immediately above C1 (Block 1330). Cells appearing in the bottom row of the grid are removed (Block 1340), and then remaining cells are all moved down by one row (Block 1350). The system identifies the program grouping P1 that precedes the program grouping that was previously at the top of the grid, within the current ordering of program groupings down the vertical axis. EPG data associated with the program grouping P1 is allocated to new cells, which are placed in the top row of the grid (Block 1360). Then the process reallocates labels on vertical axis to correspond to new cell positions (Block 1370) In case where the system moves more than one row at a time in response to a “move up” command. The process is similar, but with multiple rows being removed at the bottom and added at the top, and with the new active cell being multiple rows above the previous active cell. It will be obvious to those skilled in the art that it is possible to vary the order in which these operations of activation/deactivation, removal, adding and moving of cells are performed without departing from the inventive concept described herein.

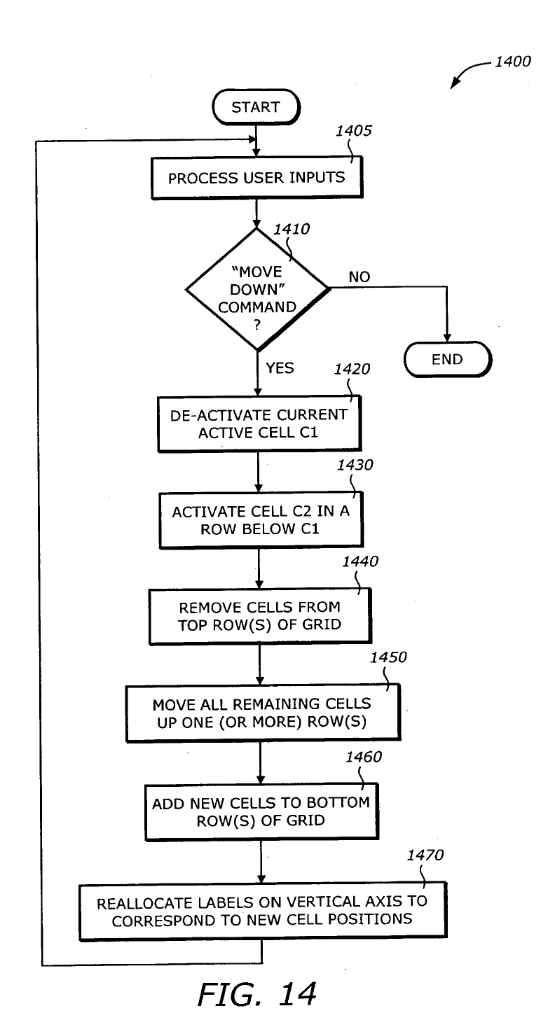

The process 1400 in FIG. 14 provides a detailed description of the method for responding to a “move down” command, which is essentially the opposite of the “move up” method. An example of how this method is applied may be seen by referring to FIGS. 7 and 10. Process 1400 receives a “move down” command (Block 1410) from a user input. Process 1400 then deactivates the current active cell C1 (Block 1420) and activates cell C2 in a row below C1 (Block 1430). The system removes cells from top row(s) of the grid (Block 1440) and moves all remaining cells up one (or more) row(s) (Block 1450). Then the system adds new cells to bottom row(s) of grid (Block 1460) and reallocates labels on the vertical axis to correspond to new cell positions (Block 1470).

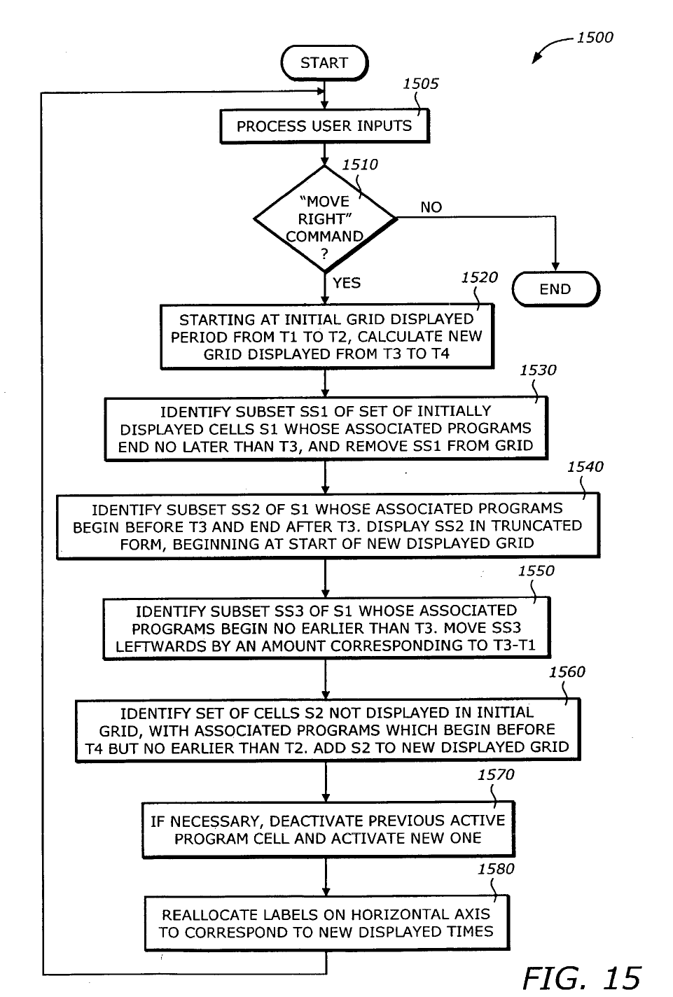

Since in the typical arrangement, cells in the horizontal dimension may be of different sizes with boundaries that do not align with each other on the various rows, horizontal grid navigation is more complex. Many different algorithms are possible for determining the exact amount of horizontal motion that is appropriate in each case, and some of these are described further herein. However, FIG. 15 provides a flowchart for responding to “move right” navigation commands in accordance with the present invention, regardless of the particular method chosen for determining what the exact amount of horizontal motion should be.

The process 1500 is shown in FIG. 15 where a “move right” command is received from user input (1510). Starting at the initial grid displayed period from T1 to T2, the process 1500 calculates new grid displayed period from T3 to T4 (Block 1520). The system identifies subset SS1 of set of the initially displayed cells S1 whose associated programs end no later than T3, and removes SS1 from grid (Block 1530). The system then identifies the subset SS2 of S1 whose associated programs begins before T3 and end after T3. Beginning at the start of new displayed grid, the system displays SS2 in truncated form (Block 1540). The system continues to identify subset SS3 of S1 whose associated programs begin no earlier than T3 then move SS3 leftwards by an amount corresponding to T3-T1 (Block 1550). Then the system identifies set of cells S2 that are not displayed in initial grid, with associated programs, which begin before T4 but no earlier than T2. The system adds S2 to new displayed grid (Block 1560). If necessary, the system deactivates previous active program cell and activates a new one (Block 1570) before reallocating labels on horizontal axis to correspond to new displayed times (Block 1580).

An example of the method of FIG. 15 can be seen by referring to FIGS. 7 and 11, where FIG. 11 represents the system state after responding to a “move right” command starting from a system state as shown in FIG. 7. In this case, the initial grid displayed period (T1 to T2) is from 2.00 pm to 3.30 pm, and the new grid displayed period (T3 to T4) is calculated to be 2.30 pm to 4.00 pm. The subset of displayed cells SS1 is therefore identified as the cells associated with the two programs “Alien Nation” and “Sweet Poison”, and these are removed from the grid. The subset SS2 in this case is the cells associated with the programs “College Basketball”, “BAT 21”, “Public Affairs”, “Backstory”, “Anatomy of a Murder” and “To Sir, With Love”. These are all displayed in truncated form at the beginning of the grid of FIG. 11. In this embodiment of the invention, indicators are placed at the beginning of these cells to indicate that their start times are actually earlier than the beginning of the grid, which distinguishes them from the program “The China Lake Murders”, whose start coincides with the beginning of the grid shown in FIG. 11. Note that in some cases the cells of SS2 have been displayed with truncation at the beginning and/or at the end in the initial grid; e.g. “BAT 21”, “Public Affairs”, “Anatomy of a Murder”. The cells of SS2 may be truncated at the end in the final state (e.g., “Anatomy of a Murder” in FIG. 11), or they may have no truncation at the end (e.g., “Public Affairs” in. FIG. 11). Continuing with the flowchart of FIG. 15, the subset of displayed cells SS3 is identified as the cells associated with the programs “SportsCenter”, “Raiders of the Lost Ark”, “The It Factor” and “The China Lake Murders”. These cells are moved leftwards in the grid of FIG. 11, by a distance corresponding to T3−T1, which in this case is 30 minutes. If the end times of their associated programs are later than T4, the cells of SS3 may appear truncated at the end of the grid (e.g. “Raiders of the Lost Ark” in FIG. 11). The set of cells S2 is identified by examining the EPG data for the program groupings displayed in the initial grid's rows to determine whether there are any programs which air at some time during the period T3 to T4, which are not associated with cells in the initial grid. In this example the displayed program groupings are the channels 76, 22, 52, 15, 68, 59 and 44, and S2 is identified as “Friends”, “Bush” and the 3.30-4.00 pm episode of “The It Factor”, and these are added to the grid of FIG. 11. In this example the active program cell of FIG. 7, “Backstory”, is deactivated and “Raiders of the Lost Ark” is made active in FIG. 11. Finally, the labels along the horizontal axis are reallocated to reflect the new grid displayed period of 2.30 pm to 4.00 pm. In general, the new grid start time T3 will be greater than the initial grid start time T1, but in response to each “move right” command T3 may be earlier, later or the same as T2, depending upon the particular method chosen to determine the amount of change in the grid displayed period (as described further below) and the particular EPG data associated with the program groupings for the rows of the displayed grids.

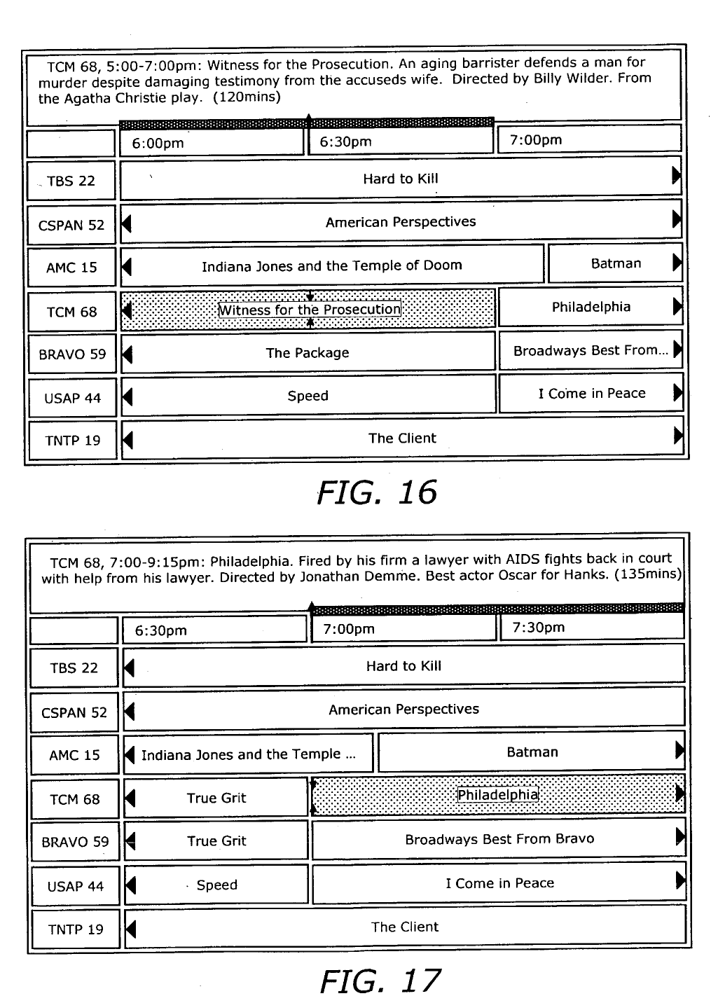

Each of the subsets SS1, SS2, SS3 and the new set S2 referred to in FIG. 15 may in some cases be empty, depending upon the particular EPG data associated with the channel groupings appearing in a particular grid when a “move right” command is issued. For example, starting from an initial system state as shown in FIG. 16, one embodiment of the invention may determine that an appropriate new grid displayed period is from 6.30 pm to 8.00 pm, as shown in FIG. 17. In this case, SS1 is empty because all the programs associated with cells displayed in FIG. 16 have end times later than T3, which in this case is 6.30 pm.

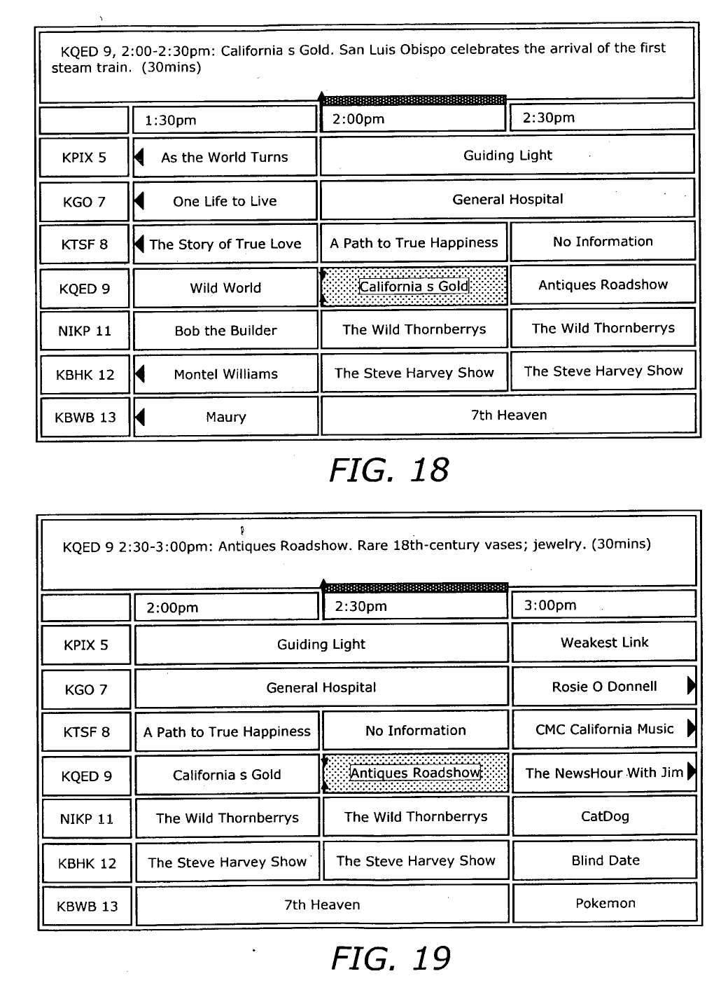

FIGS. 18 and 19 show example system states before and after a “move right” command according to FIG. 15, wherein the subset of displayed cells SS2 is empty. T3 is in this case 2.00 pm, and there is no program airing on the channels shown in the rows of the initial grid, Which both starts before 2.00 pm and ends after 2.00 pm.

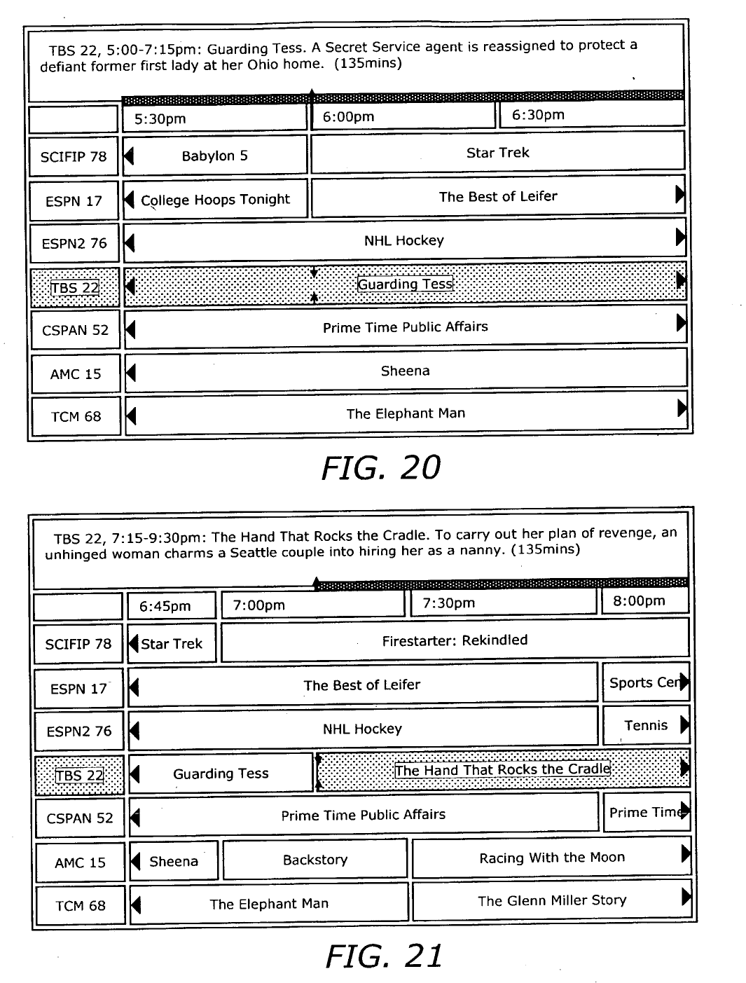

FIGS. 20 and 21 show example system states before and after a ‘move right” command according to FIG. 15, wherein the subset of displayed cells SS3 is empty. T3 is in this case 6.45 pm, and there is no program in the initial grid which begins at or later than 6.45 pm.

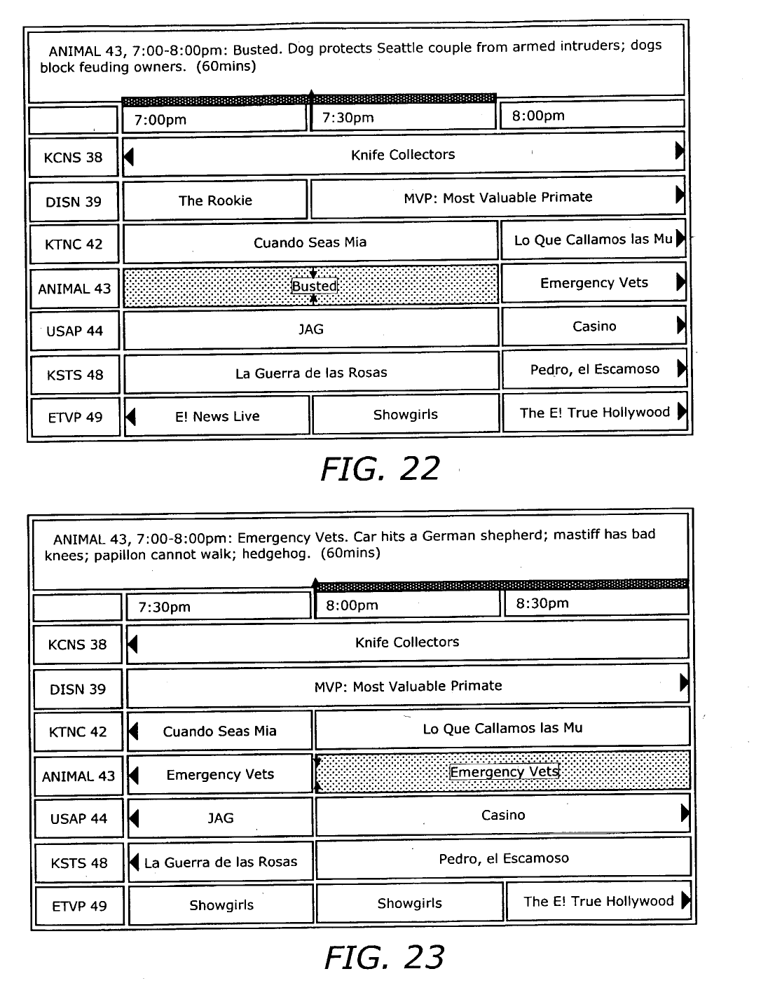

FIGS. 22 and 23 show example system states before and after a “move right” command according to FIG. 15, wherein the set of new cells S2 is empty. T2 is in this case 8.30 pm and T4 is 9.00 pm, and there is no program airing on the channels shown in the rows of the initial grid, which begins before 9.00 pm but at a time at or after 8.30 pm.

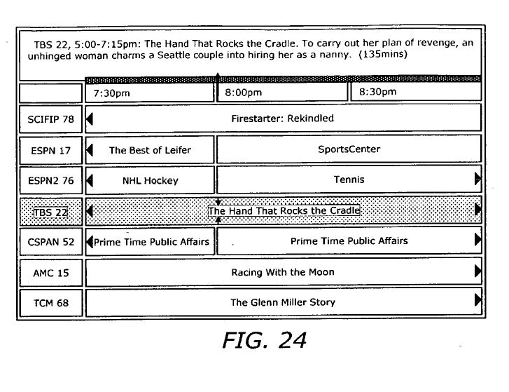

The preceding examples have shown cases where the initially active program cell is deactivated and a new cell is active in the final grid. FIG. 24 shows an example final grid where, starting from an initial grid as in FIG. 21, the method according to FIG. 15 produces a resulting grid with the same active program cell “The Hand That Rocks the Cradle” as in the initial state.

Labels are reallocated on the horizontal axis to correspond to the newly displayed times. The system may place these labels to indicate half-hour boundaries, but it is not necessary that the start and end of the grid displayed period be so aligned, as can be seen in FIG. 21.

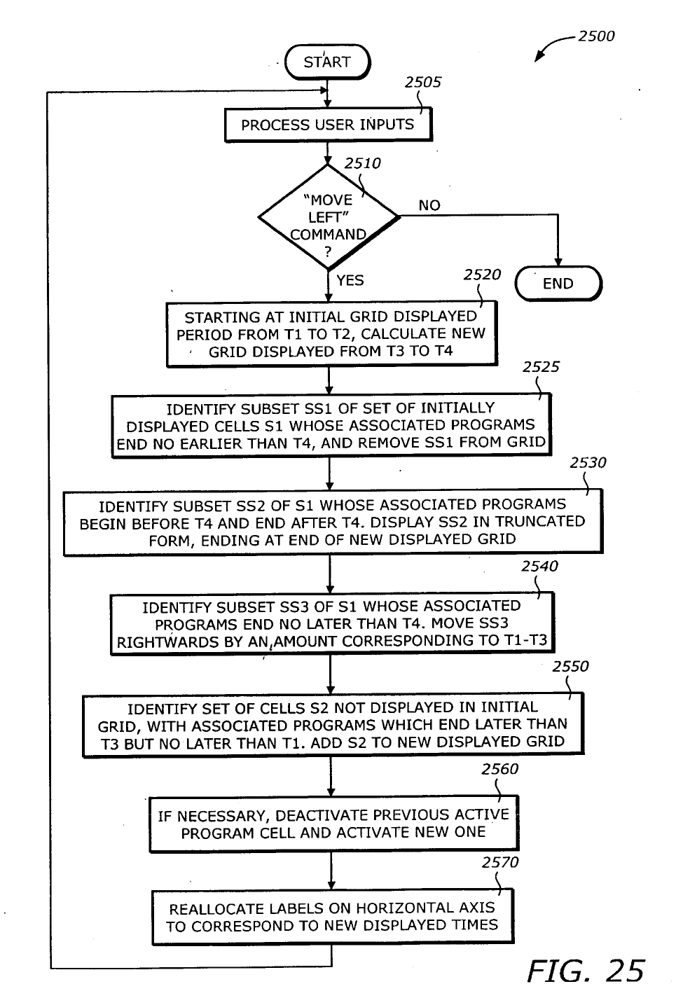

The process 2500 in FIG. 25 shows a flowchart for responding to a “move left” command according to the methods of the present invention, regardless of the particular method chosen for determining what the exact amount of horizontal motion should be.

The system receives a “move left” command (Block 2510) from a user input. Starting at an initial grid displayed period from T1 to T2, the system calculates new grid displayed period from T3 to T4 (Block 2520). The system first identifies subset SS1 of set of initially displayed cells S1 whose associated programs start no earlier than T4, and removes SS1 from the grid (Block 2520). Second, the system identifies subset SS2 of S1 whose associated programs begins before T4 and end after T4 and displays SS2 in truncated form, ending at the end of new displayed grid (Block 2530). Third, the system identifies subset SS3 of S1 whose associated programs end no later than T4 and moves SS3 rightwards by an amount corresponding to T1-T3 (Block 2540). Fourth, the system identifies the set of cells S2 not displayed in the initial grid, with associated programs which end later than T3 but no later than T1 and adds S2 to a new displayed grid (Block 2550). If necessary, the system deactivates previous active program cell and activates a new one (Block 2560). The system then relocates labels on horizontal axis to correspond to new displayed times (Block 2570). It will be obvious to those skilled in the art that it is possible to vary the order in which these operations of activation/deactivation, removal, adding and moving of cells are performed without departing from the inventive concept described herein.

An example of the method of FIG. 25 can be seen by referring to FIGS. 7 and 12, where FIG. 12 represents the system state after responding to a “move left” command starting from a system state as shown in FIG. 7. In this case, the initial grid displayed period (T1 to T2) is from 2.00 pm to 3.30 pm, and the new grid displayed period (T3 to T4) is calculated to be 12.00 to 1.30 pm. The subset of displayed cells SS1 is therefore identified as the cells associated with the two programs “Anatomy of a Murder” and “BAT 21”, and these are removed from the grid. The subset SS2 in this case includes the cells associated with the programs “College Basketball”, “Public Affairs”, “Alien Nation”, “To Sir, With Love” and “Sweet Poison”. These are all displayed in truncated form at the end of the grid of FIG. 12. In this embodiment of the invention, indicators are placed at the end of these cells to indicate that their end times are actually later than the end of the grid, which distinguishes them from the program “Uncommon Valor”, whose end coincides with the end of the grid shown in FIG. 12. Note that in this particular case the cells of SS2 have all been displayed with truncation at the beginning in the initial grid, and “Public Affairs” has also been displayed with truncation at the end in the initial grid of FIG. 7. The cells of SS2 may also be truncated at the beginning in the final state (e.g. “Public Affairs” in FIG. 12), or they may have no truncation at the beginning (e.g. “Sweet Poison” in FIG. 12). Continuing with the flowchart of FIG. 25, the subset of displayed cells SS3 is empty in this example, since T4 is in this case 1.30 pm, and there are no cells in the grid of FIG. 7 with end times at or before 1.30 pm. The set of cells S2 is identified by examining the EPG data for the program groupings displayed in the initial grid's rows to determine whether there are any programs which air at some time during the period T3 to T4, which are not associated with cells in the initial grid. In this example the displayed program groupings are the channels 76, 22, 52, 15, 68, 59 and 44, and S2 is identified as the 11.00 am to 1.00 pm episode of “College Basketball”, “Uncommon Valor”, “True Grit”, “The Caine Mutiny”, “The Cotton Club and Matter of Trust”, and these are added to the grid of FIG. 12. In this example the active program cell of FIG. 7, “Backstory”, is deactivated and “Alien Nation” is made active in FIG. 12. Finally, the labels along the horizontal axis are reallocated to reflect the new grid displayed period of 12.00 to 1.30 pm. In general the new grid end time T4 will be earlier than the initial grid end time T2, but in response to each “move left” command T4 may be earlier, later or the same as T1, depending upon the particular method chosen to determine the amount of change in the grid displayed period and the particular EPG data associated with the program groupings for the rows of the displayed grids.

Each of the subsets SS1, SS2, SS3 and the new set S2 referred to in FIG. 25 may in some cases be empty, depending upon the particular EPG data associated with the channel groupings appearing in a particular grid when a “move left” command is issued. For example, starting from an initial system state as shown in FIG. 17, one embodiment of the invention may determine that an appropriate new grid displayed period is from 6.00 pm to 7.30 pm, as shown in FIG. 17. In this case, SS1 is empty because all the programs associated with cells displayed in FIG. 17 have start times earlier than T4, which in this case is 7.30 pm. Furthermore, in this case S2 is also empty, because on the channels associated with the rows of the initial grid, there are no programs, which end after 6.00 pm but not after 6.30 pm.

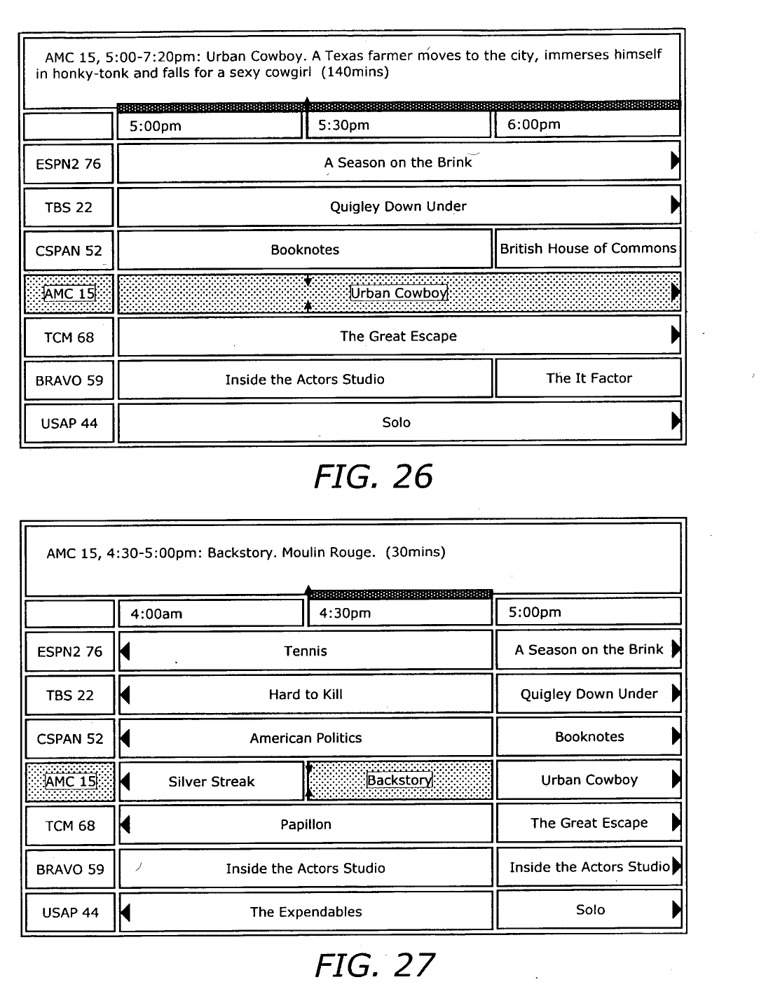

The previous discussion noted that SS3 is empty in the example of the move from FIG. 7 to FIG. 12, in which T4 is earlier than T1. SS3 may also be empty in cases where T4 is later than T1, as in FIGS. 26 and 27. From an initial state as shown in FIG. 26, an embodiment of the invention may determine that an appropriate new grid displayed period in response to a “move left” command is from 4.00 pm to 5.30 pm. In this case, there are no programs in the initial grid whose end time is not later than T4.

An example where the subset SS2 is empty may be seen by referring again to FIGS. 19 and 18. An embodiment may determine that, from an initial grid as shown in FIG. 19, an appropriate new grid displayed period in response to a “move left” command is from 1.30 to 3.00 pm. In this case T4 is 3.00 pm, and there are no programs in the grid of FIG. 19, which both begin before 3.00 pm and end after 3.00 pm. However, SS3 is not empty in this case. In the initial grid, the programs “Guiding Light”, “General Hospital”, “Antiques Roadshow”, the 2.30-3.00 pm episodes of “The Wild Thornberrys” and “The Steve Harvey Show”, and “7^{th} Heaven” all have end times no later than 3.00 pm, and these are identified as the subset SS3. Note that although other programs such as “California's Gold” and the 2.00 pm-2.30 pm episodes of “The Wild Thornberrys” and “The Steve Harvey Show” also end before 3.00 pm, these are identified as part of subset SS1 and removed from the final grid. The cells of SS3 are moved rightwards in the grid by T1-T3, which in this case is 30 minutes.

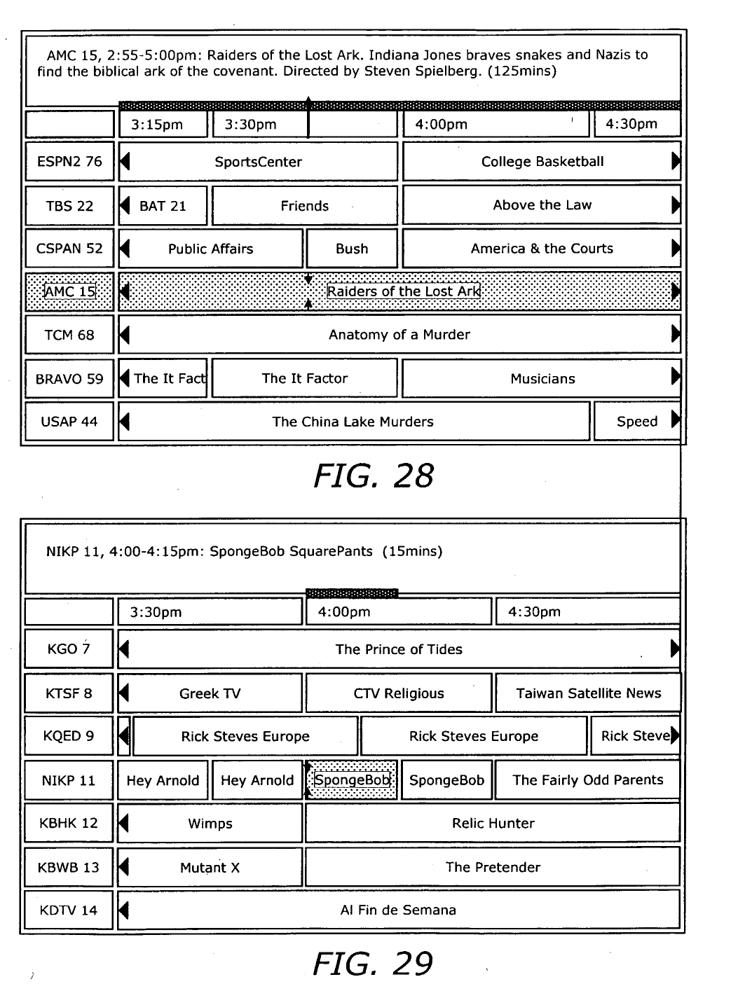

The preceding examples have shown cases where the initially active program cell is deactivated and a new cell is active in the final grid. FIG. 28 shows an example initial grid where the method according to FIG. 25 may produce a resulting grid as shown in FIG. 11, and in this case the same active program cell “Raiders of the Lost Ark” is also active in the final state.

Various methods may be used to calculate an appropriate new grid displayed period for each navigational command. For example, a grid-based method may be used to determine the new position of the underlying focal point from program information associated with all rows visible in the current grid. If the method used positions the focal point at horizontal positions corresponding to every program boundary in the visible rows of the grid, the system of the current invention will produce navigational behavior, which is entirely symmetrical in left-right motion. In this case, any “move right” command followed by a “move left” command, or vice versa, is guaranteed to leave the system in the same state as before the pair of navigation commands.

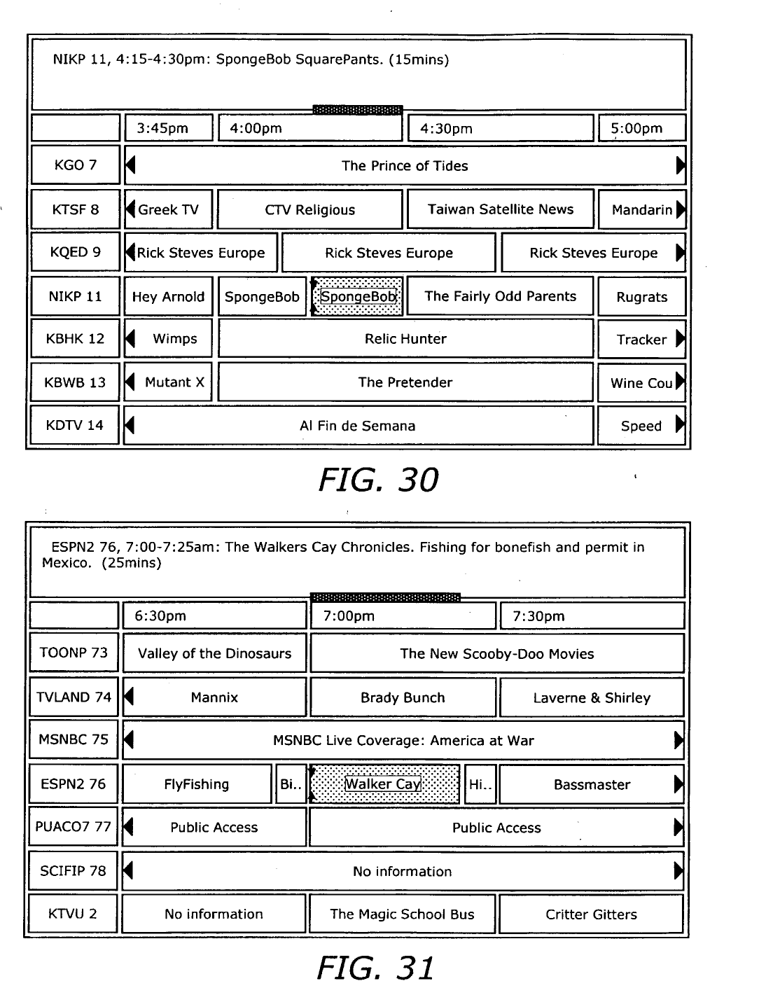

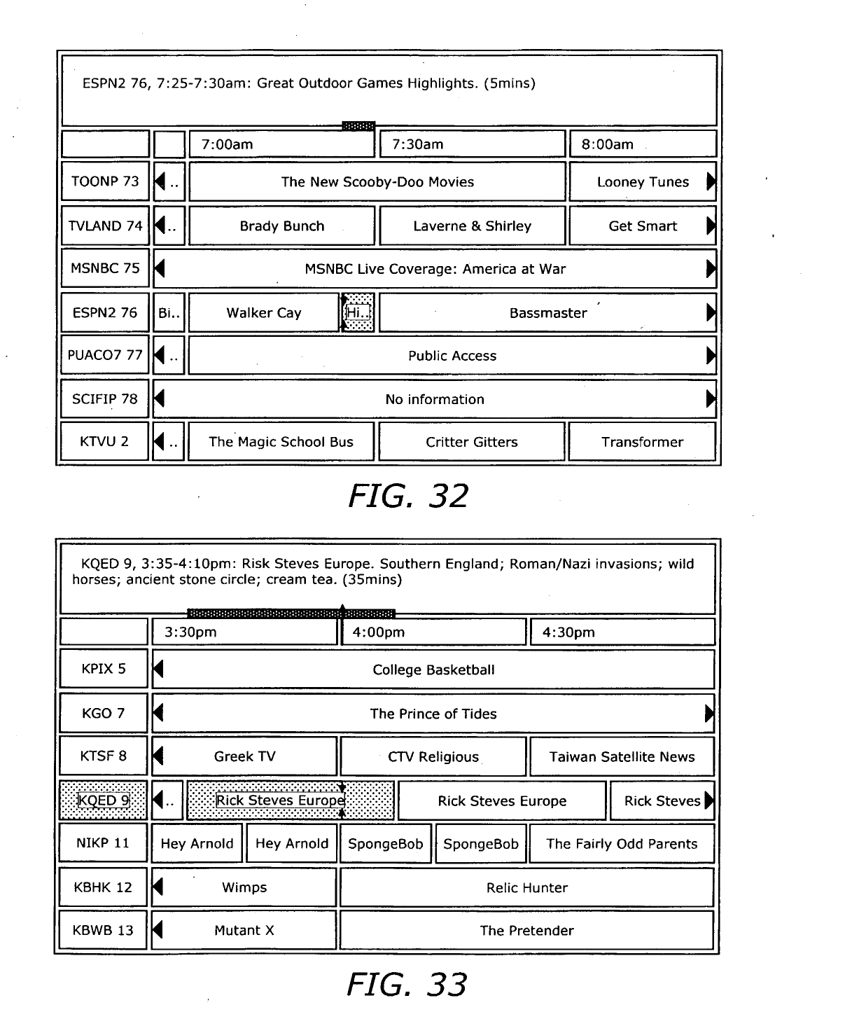

Alternatively, a variety of techniques may be used to calculate the new grid displayed period, based upon the information for the currently active grid row. For example, the new grid displayed period may be calculated so as to leave the focal point at the beginning of the next program on the currently active grid row. FIGS. 29 and 30 illustrate examples of this approach, wherein a “move right” command from an initial state as shown in FIG. 29 will result in a state as shown in FIG. 30, and also a “move left” command from an initial state as shown in FIG. 30 will result in a state as shown in FIG. 20. Using the same approach of calculating the grid displayed period so as to leave the focal point corresponding to the beginning of the next program in the required direction of motion, a “move right” from an initial state as in FIG. 31 will result in a state as in FIG. 32, and a “move left” from an initial state as in 32 will result in a state as in FIG. 31. Various techniques such as this may be used with the present invention to provide left/right navigational behavior, which is again entirely symmetrical, even though the motion calculations are only based upon the data associated with one row of the grid. This distinguishes the present invention from previous EPG systems, which have asymmetries of various kinds in their navigation behaviors.

FIG. 32 illustrates a case where, for an embodiment in which the stable underlying focal point corresponds to a point 30 minutes from the start of the grid, it is possible to have a grid displayed period which begins five minutes before a half-hour boundary. The active cell in this grid corresponds to the program “Great Outdoor Games Highlights”, which begins at 7.25 am. In such cases, there may be a variety of means used to indicate the amount of time that precedes the half-hour boundary, using the limited display area that corresponds to this period. In the example shown the text “(5)” is shown in a smaller font than the other labels on the horizontal axis, to indicate that five minutes of programming precedes the first axis label indicating 7.00 am. It can also be seen from FIG. 32 that even in such grids, there may be program cells such as that corresponding to the 6.55 am-7.00 am program “Hunt for Big Fish” on ESPN76 which fit entirely into this small span of the horizontal axis.

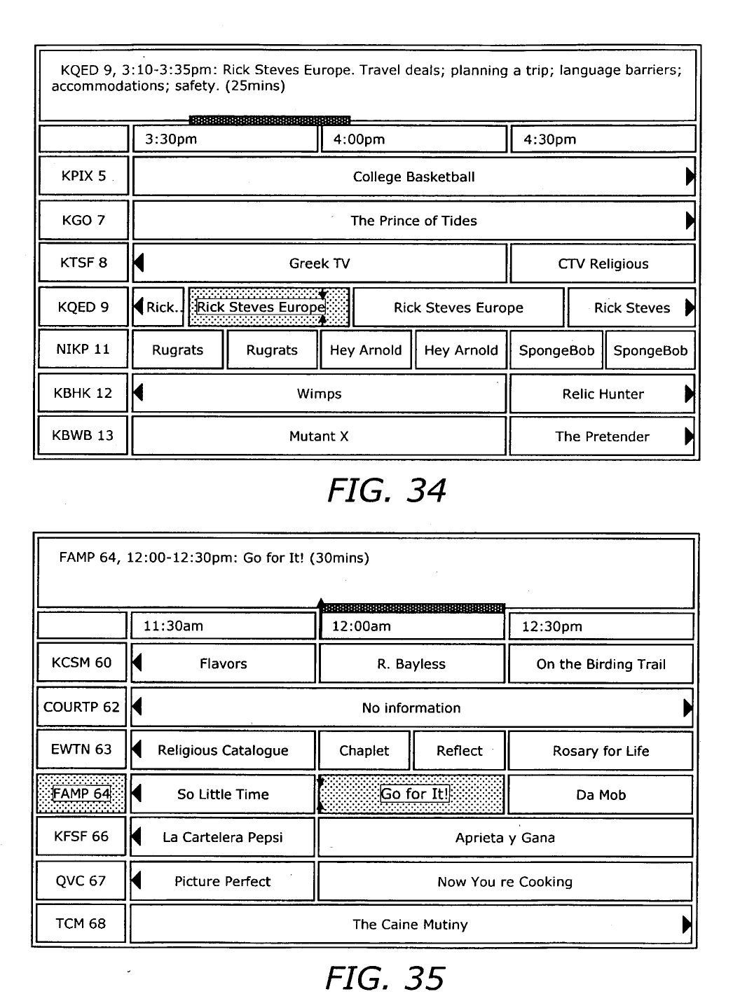

Still other varieties of techniques may be used for calculating the new grid displayed period, wherein data from all grid rows may be taken into account. The programs associated with the currently active grid row may be given priority in determining the appropriate period, but consideration may also be given to aligning the grid displayed period with a 30-minute boundary. For example, one method may be to normally calculate the new displayed period so that the underlying focal point corresponds to the start of the next program on the active grid row in the direction of motion, as previously discussed. However, in cases where this would result in a grid displayed period which does not align with a half-hour boundary, an alternative displayed period may be chosen which leaves the focal point corresponding to the same new active program, but not necessarily corresponding to it's start time. An example where this type of combined technique for determining the new grid displayed period was seen previously in FIGS. 7 and 11. Starting from FIG. 7, a method that simply aligned the underlying focal point with the start of the next program might calculate a new grid displayed period from 2.25 pm to 3.55 pm. But an alternative method might in this case also take into account the start times of programs on other grid rows, and use a grid-based calculation such as described in copending application Ser. No. 10/065,889 to determine that a new displayed period of 2.30 to 4.00 pm would align with program starts on other rows, leave the grid displayed period aligned with a half-hour boundary, and still result in the same active program “Raiders of the Lost Ark” as in the simpler row-based approach. In this example, the resulting change in the grid displayed period is greater than would have occurred with a simpler row-based approach. FIGS. 33 and 34 illustrate a case wherein the grid displayed period may change by a smaller amount than would occur using a simple row-based algorithm that aligns the stable underlying focal point with the start of the next program in the direction of motion. Starting from an initial state as shown in FIG. 33, a more sophisticated algorithm may take into account the fact that the start of the 3.10-3.35 episode of “R. Steves” is not aligned with a half-hour boundary, but a smaller move to leave the underlying focal point at 3.30 pm will still leave this program active, with the grid displayed period aligned with a half hour boundary, and the underlying focal point also at a time corresponding to the start of the 3.30 episode of “Hey Arnold” on channel 11.

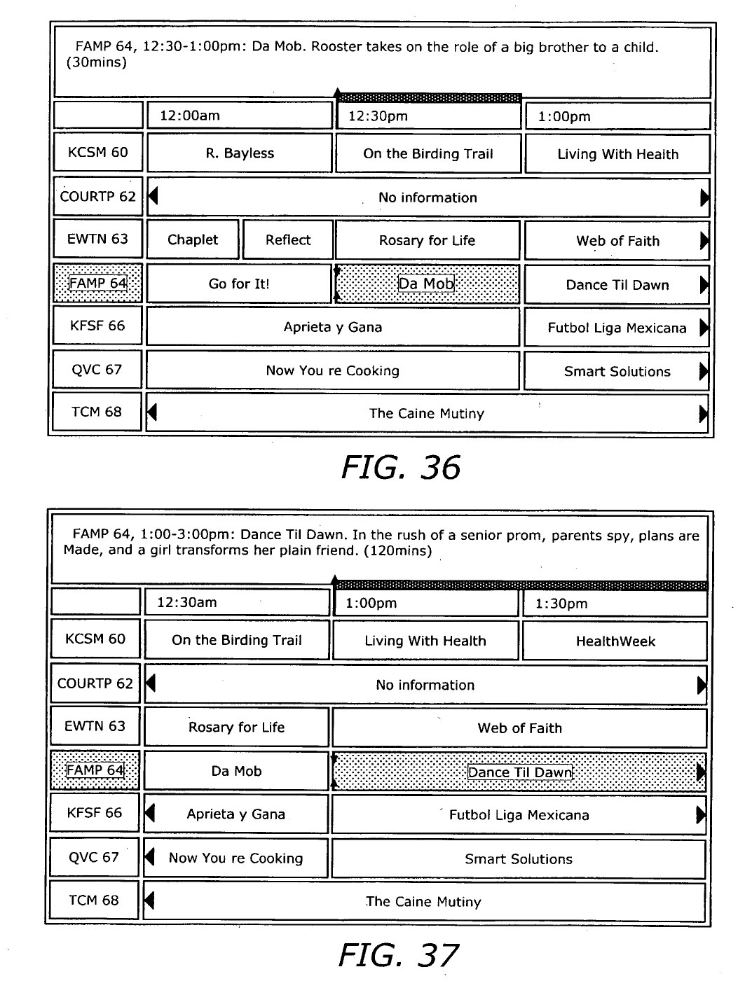

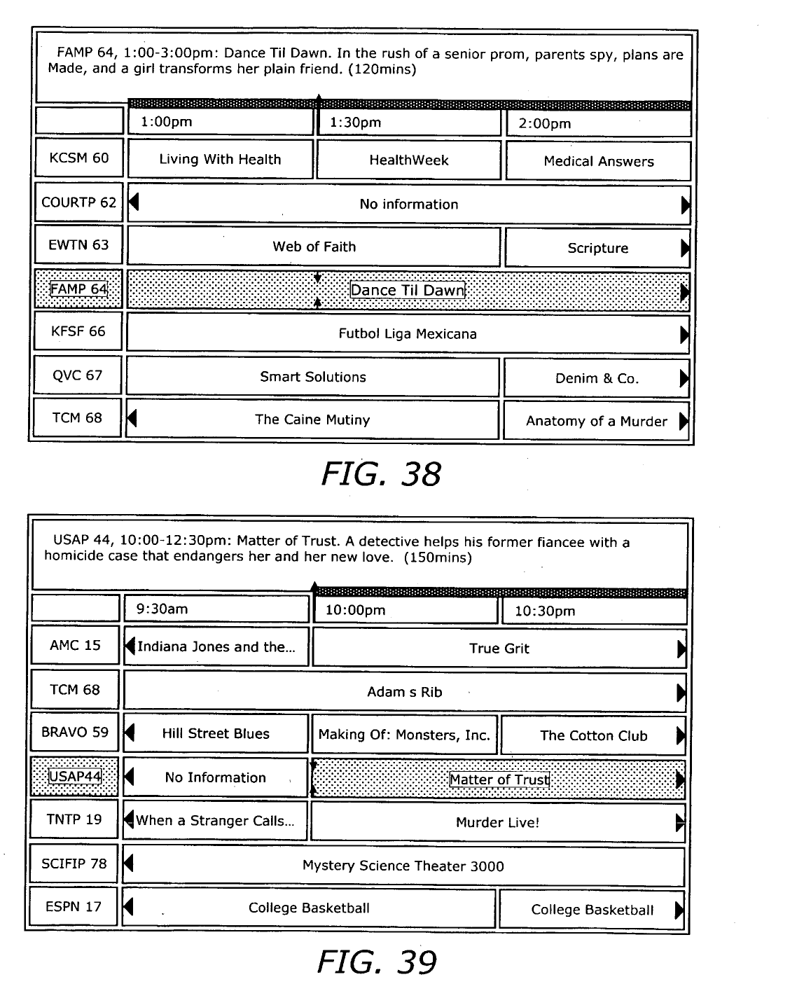

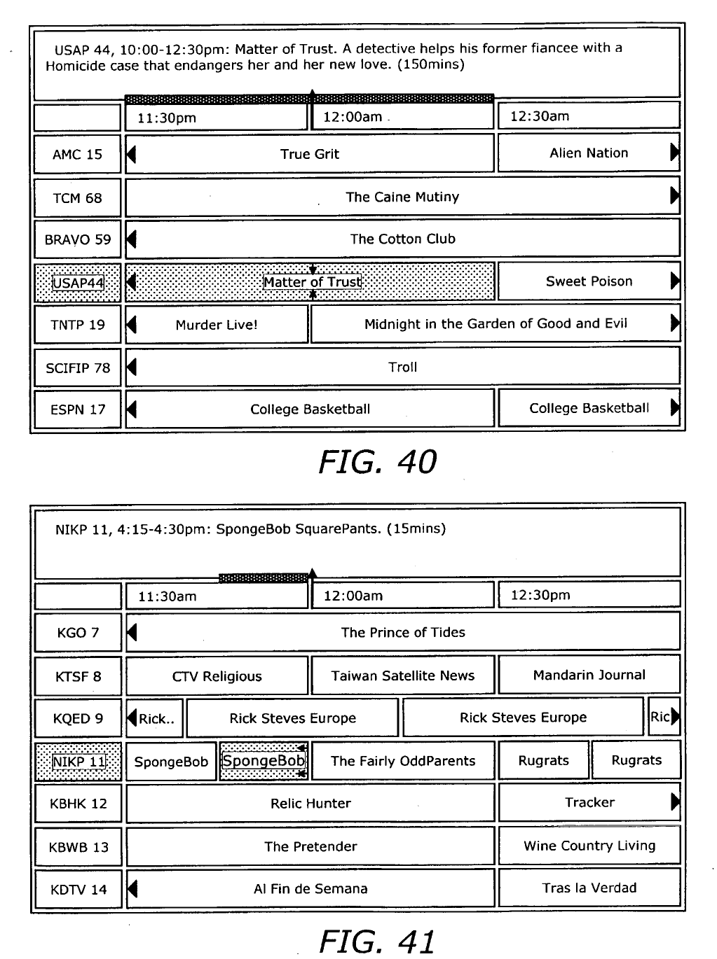

Other novel methods may be used to determine the new grid displayed period in response to a horizontal navigation command. For example, a grid-based method may be combined with a row-based method, such that the row-based is always used if the resulting movement is less than or equal to a predetermined amount (for example, 30 minutes), but if the row-based movement would result in a movement greater than that amount, then a grid-based calculation of the movement is made (which may still result in a movement greater than the predetermined amount). An example of this type of embodiment is shown in FIGS. 35 to 38. Starting from an initial state as shown in FIG. 35, this method responds to a “move right” command with the grid as shown in FIG. 36. This is a row-based move of 30 minutes, according to a method which aligns the underlying focal point with the start of the next program, which does not stop at a point corresponding to the 12.15 pm program Reflect on channel 63, as many grid-based methods would. The next row-based move from the state shown in FIG. 36 to that shown in FIG. 37 is also 30 minutes, but this time no programs on other rows are skipped. Finally, the candidate row-based move from an initial state as shown in FIG. 37 is 120 minutes (since the program “Dance Til Dawn” is 120 minutes long), and in this case it exceeds the predetermined maximum move for a row-based move. The system therefore employs a grid-based calculation to determine the new grid displayed period, which is as shown in FIG. 38, with the new position of the underlying focal point at a horizontal position which corresponds to the start of the program “HealthWeek” on channel 60. However, this approach does not limit movements to the predetermined amount, as prior global limit methods do. For example, using the same grid-based method combined with the row-based method, starting from an initial state as shown in FIG. 39, the system calculates that a row-based move would be 150 minutes, to place the start of the program “Sweet Poison” over the focal point. However, since this is larger than the predetermined 30 minute maximum for a row-based move, the system makes a grid-based calculation using points of new information and information loss for each row, and makes a 120 minute move to result in the grid as shown in FIG. 40. Thus the overall effect of this type of combined algorithm is to always make large moves according to the grid-based method, which ensures that only very short shows on rows, which are not currently active, are ever “skipped” by a horizontal move.

Other variations of the combination of grid-based and row-based methods for calculating the new grid displayed period may also be used. For example, a grid-based method may be normally used, except when this would result in a grid displayed period that is not aligned with a 30-minute boundary. In such cases an alternative amount of movement may be chosen that results in the same active program in the final state as would have occurred with the standard grid-based method, but with the underlying focal point corresponding to some point in the program other than its start, so that the grid displayed period aligns with a half hour boundary.

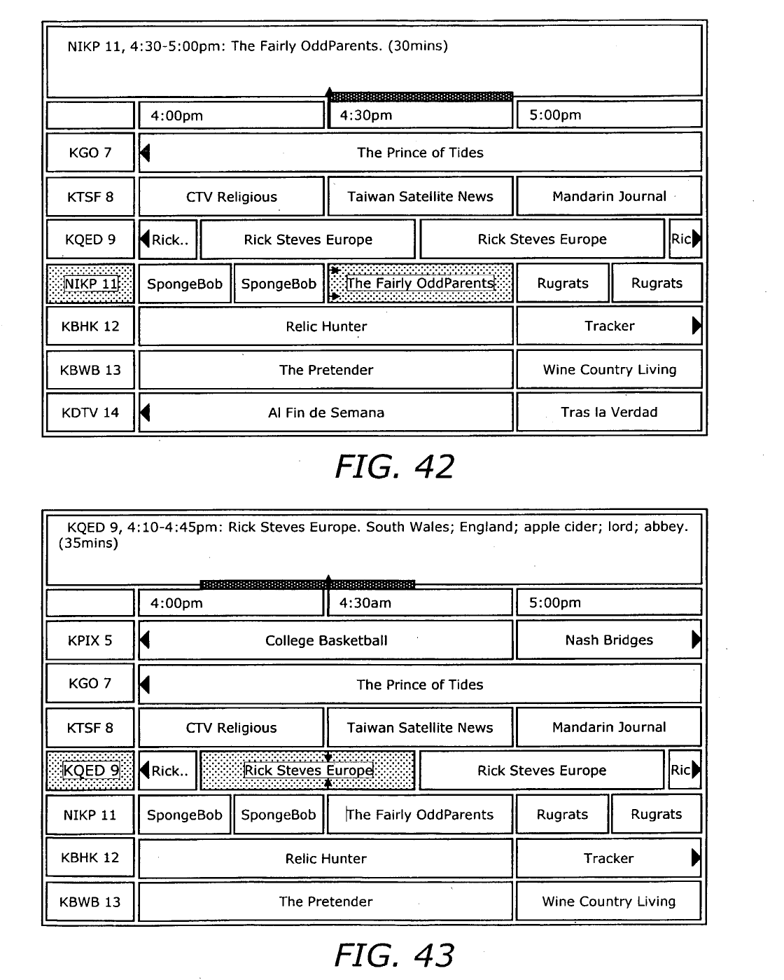

According, to a second embodiment of the invention, the use of a stable underlying focal point may be combined with the use of multiple different means of visually indicating the active cell. In previous systems, the same type of visual indication of the active cell is used constantly throughout EPG grid navigation. Typical visual indications used previously two-dimensional cell highlighting or other graphical means of indicating the entire cell. More recent methods such as those disclosed in copending application Ser. No. 10/065,075 employ a one-dimensional line, icon or other means for indicating a single active point in time. However, the present invention contemplates using at least three distinct graphical forms to indicate the active cell, depending upon whether the active point in time is at the beginning, somewhere in the middle or at the end of the active program cell. FIGS. 41 through 43 show examples of this, wherein the underlying focal point corresponds to the end, beginning and middle of the active program cell, respectively. Three different sets of arrows are used to indicate the relative positions of the underlying focal point and active cell, and in these examples, these visual elements are also combined with highlighting of the entire cell (although such highlighting is not necessary to uniquely identify the active cell). Thus according to this novel method, a move right command starting from the system state shown in FIG. 41 results in the grid of FIG. 42, and a “move left” command starting from the grid of FIG. 42 results in the figure of 41. In these cases, the amount of movement of the visible window in response to the navigation command is zero, and the focal point itself also remains in exactly the same position, but the active cell changes. This removes the conventional restriction adopted in prior point-based systems, that when the active point in time lies at the boundary between two programs, the active program is always taken to be the program on the right. In response to a “move up” command from either the state of FIG. 41 or 42, the result is the grid shown in FIG. 43, where the graphical element indicating the active cell also indicates that the underlying focal point is “in the middle”, which in this context simply means not coinciding with one of the cell boundaries.

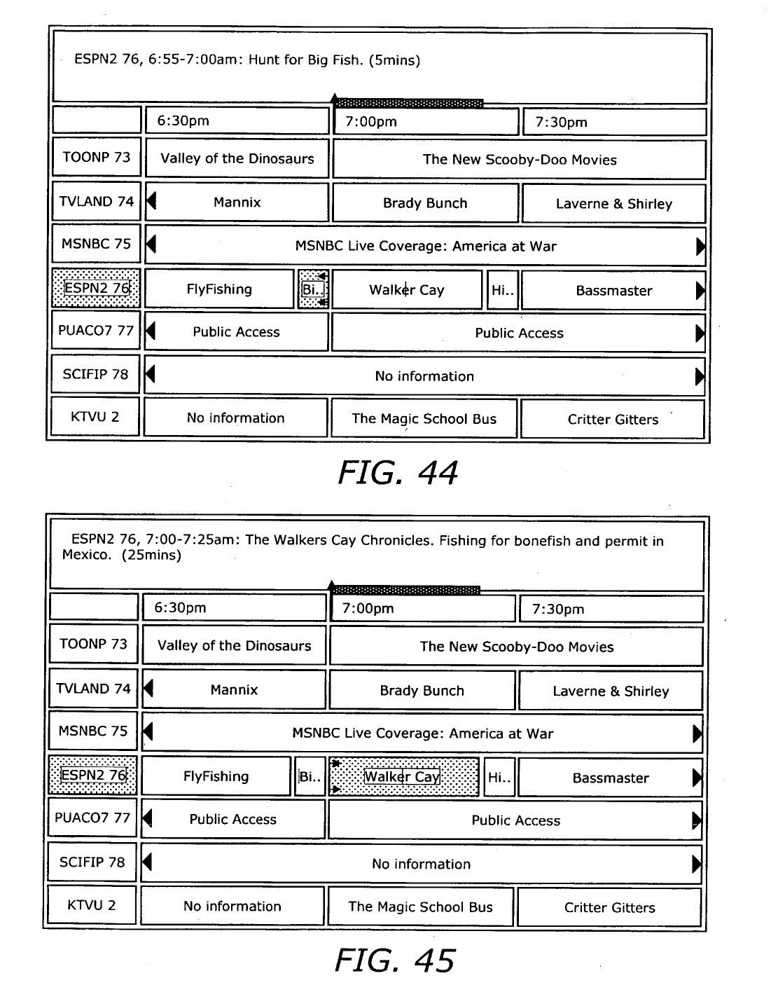

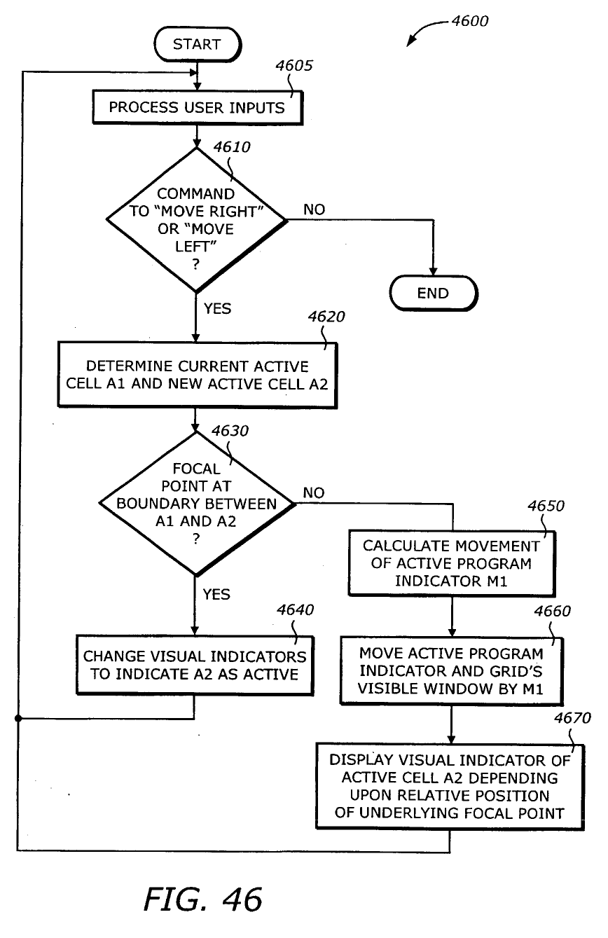

An advantage of using multiple different visual elements in this way is that it becomes possible to align the grid's displayed period with a half-hour boundary, even in cases where no half-hour boundary occurs at the start or during the airing time of the active program. FIG. 41 shows one example of this, where the 4.15-4.30 episode of “SpongeBob” is active, and the grid's displayed period starts at 4.00 pm with the underlying focal point at a position corresponding to 4.30 pm. FIG. 44 shows another example. As noted previously, a simple row-based navigation method used in conjunction with the first embodiment of the present invention calculates the new grid displayed period so as to leave the focal point at the beginning of the next program on the currently active row. Starting from an initial state as shown in FIG. 31, that method calculates a response to a move left command wherein the new grid displayed period is 6.25 to 7.55 am, with the focal point corresponding to the 6.55 pm start of “(Hunt for) Big Fish”. However, the second embodiment of the invention allows for a different response to a “move left” command, starting from a state as shown in FIG. 45 (which is similar to that shown in FIG. 31, except for the visual indication of the active cell). In this case, no change in the grid's displayed period is required, and the resulting system state is as shown in FIG. 44, with the stable focal point still lying at a horizontal position corresponding to 7.00 pm. Thus responses according to this second embodiment of the invention, from the perspective of the user of the system, may be determined according to the flowchart of FIG. 46. If a user inputs a command to “move left” or “move right”, the system determines which cell will become the next active cell A2, given the current active cell Al and the chosen method for moving between programs (for example row-based, grid-based, etc as described previously). In some cases A1 and A2 may be the same cell. If, however, A1 and A2 are different and the focal point is currently at the boundary between them, the system may not move the visible window (or, equivalently, the cells in the window and the labels on the horizontal axis), but instead may simply change the visual elements to indicate A2 as the new active cell. Otherwise, the method proceeds as with the first embodiment, except that at the end the system displays a different type of visual indication of the active cell, depending upon the relative position of the underlying focal point (i.e. at the start, end, or somewhere in the middle of A2). Thus in the examples noted previously, when moving right from FIG. 41 to FIG. 42, A1 is the cell corresponding to “SpongeBob”, and A2 is the cell corresponding to “The Fairly Odd Parents”. When moving left from FIG. 45 to FIG. 44, A1 is the cell corresponding to “Walker Cay” and A2 is the cell corresponding to “(Hunt for) Big Fish”.

FIG. 46 shows a flowchart of process 4600 for responding to navigation commands according to one embodiment of the present invention. The system receives a command to “move right” or “move left” for a user input (Block 4610). The system then determines the current active cell C1 and new active cell A2 (Block 4620). The system continues with process 4600 to find out whether the focal point is at the boundary between A1 and A2 (Block 4630). If the focal point is at the boundary between A1 and A2, the system changes the visual elements to indicate A2 as active (Block 4640). If the focal point is not at the boundary between A1 and A2, the process continues when the system calculates the movement of the active program indicator M1 (Block 4650). The system moves the active program indicator and grid's visible window by M1 (Block 4660). The system then displays the visual element of active cell A2 depending upon relative position of the underlying focal point (Block 4670).

According to another aspect of the second embodiment of the invention, an additional descriptive label may be used, wherein the label appears approximately at a horizontal position corresponding to the horizontal position of the underlying focal point. The alignment of this label may change to reflect the relative alignment of the focal point with the active grid cell, as an additional visual cue for the user. Thus in FIG. 43, the underlying focal point is near the middle of the active cell at a point corresponding to 4.30 pm, and the descriptive label “KQED 9, 4:10-4:45 pm” which appears in the supplementary information display is centrally aligned relative to the 4.30 position. In FIG. 44, the underlying focal point is at the end of the active cell at a point corresponding to 7.00 am, and the descriptive label “ESPN2 76, 6:55-7.00 am” which appears in the supplementary information display has its right boundary aligned with the 7.00 am position. In FIG. 45, the underlying focal point is at the beginning of the active cell, also at a point corresponding to 7.00 am, and the descriptive label “ESPN2 76, 7.00-7.25 am” which appears in the supplementary information display has its left boundary aligned with the 7.00 am position.

A wide variety of different embodiments of the invention are possible. The methods described herein for aligning the grid's displayed period with half-hour boundaries may also be easily adapted to provide systems that regularly align with boundaries at other intervals such as hourly, fifteen minutes, etc. Examples have been given of vertical movements of one row per navigation command, but the system may also provide movements of several rows per navigation command. In both horizontal and vertical directions, the system may provide for more than one navigation input command, such as “small move left”, “large move left”, “small move up”, “large move up”, etc, and it will be obvious to those skilled in the art how the methods described herein may be applied to these different types of command. While certain embodiments are illustrated in the drawings and have been described herein, it will be apparent to those skilled in the art that many modifications can be made to the embodiments without departing from the inventive concepts described.

1. An electronic program guide system comprising: a grid displayed on a display area having horizontal and vertical axes, the grid including a plurality of cells, each cell containing information on a program; a means for visually indicating one active cell contained within said grid; a chosen point at a constant stable position in relation to the horizontal and vertical axes, said point being an underlying focal point; wherein at least one portion of said active cell corresponds to said underlying focal point.

2. The system recited in claim 1, wherein said means is one of an icon, a two-dimensional cell highlight, and at least one visually graphical element.

3. The system recited in claim 1, further comprising a visual indication of an active row containing said active cell.

4. The system recited in claim 1, wherein said plurality of cells comprises a plurality of rows disposed along the vertical axis, each row containing at least one cell.

5. The system recited in claim 4, wherein the horizontal axis represents time, wherein the beginning of the grid represents the start of a grid displayed period and the end of the grid represents the end of a grid displayed period, andwherein said vertical axis represents program grouping.

6. The system recited in claim 5, wherein a plurality of labels appears on said horizontal axis denoting times between the start of said displayed period of said grid and the end of said displayed period of said grid.

7. The system recited in claim 5, wherein said constant stable position of said point lies at a position approximately in the middle of said vertical axis.

8. The system recited in claim 5, wherein, in response to one of a move up and a move down command, said active cell is reallocated to a new position, and a second cell becomes the active cell.

9. The system recited in claim 8, wherein prior to said command, information for a first set of programs associated with at least a first program grouping appears in cells located in at least a first row of said grid.

10. The system recited in claim 5, wherein, in response to one of a move right and a move left command, at least one of said plurality of cells is reallocated to a new position.

11. The system recited in claim 5, wherein said constant stable position of said point lies at a position along the horizontal axis corresponding to a first period of time after the start time of said grid.

12. The system recited in claim 11, wherein said first period of time is a positive integer multiple of a predefined time interval.

13. The system as recited in claim 12 wherein the predefined time interval is a multiple of 5 minutes.

14. The system recited in claim 1, wherein said means comprises a vertically oriented information line.

15. The system recited in claim 14, wherein said information line intersects a plurality of said cells.

16. The system recited in claim 15, wherein said information line comprises a visually distinguished segment for indicating said one active cell.

17. A method comprising: displaying on a display area having horizontal and vertical axes a grid, the grid including a plurality of cells, each cell containing information on a program; visually indicating one active cell contained within said grid; choosing a point at a constant stable position in relation to the horizontal and vertical axes, said point being an underlying focal point; and wherein at least one portion of said active cell corresponds to said underlying focal point.

18. The method of claim 17 further comprising visually indicating an active row containing said active cell.

19. The method of claim 17 further comprising reallocating at least one of said plurality of cells to a new position in response to a user command of one of a move up, move down, move left, and move right.

20. An article of manufacturing comprising: a machine accessible medium including data that, when accessed by a machine, causes the machine to perform operations comprising: displaying on a display area having horizontal and vertical axes a grid, the grid including a plurality of cells, each cell containing information on a program; visually indicating one active cell contained within said grid; choosing a point at a constant stable position in relation to the horizontal and vertical axes, said point being an underlying focal point; wherein at least one portion of said active cell corresponds to said underlying focal point.

21. The article of manufacture of claim 20 wherein the data further comprises data that, when accessed by the machine, causes the machine to perform operations comprising reallocating at least one of said plurality of cells to a new position in response to a user command to one of a move up, move down, move left, and move right.

22. A system comprising: a processor, and a memory coupled to the processor, the memory containing program code that, when executed by the processor, causes the processor to: display on a display area having horizontal and vertical axes a grid, the grid including a plurality of cells, each cell containing information on a program; visually indicate one active cell contained within said grid; choose a point at a constant stable position in relation to the horizontal and vertical axes, said point being an underlying focal point; wherein at least one portion of said active cell corresponds to said underlying focal point.

23. The system recited in claim 22, wherein said visual indicating is performed by one of an icon, a two-dimensional cell highlight, and at least one visually distinguished graphical element.

24. The system recited in claim 22 further comprising a visual indication of an active row containing said active cell.

25. The system recited in claim 22, wherein said plurality of cells comprises a plurality of rows disposed along the vertical axis, each row containing at least one cell.

26. The system recited in claim 25, wherein the horizontal axis represents time, wherein the beginning of the grid represents the start of a grid displayed period and the end of the grid represents the end of a grid displayed period, andwherein said vertical axis represents program grouping.

27. The system recited in claim 26, wherein a plurality of labels appears on said horizontal axis denoting times between the start of said displayed period of said grid and the end of said displayed period of said grid.

28. The system recited in claim 26, wherein said constant stable position of said point lies at a position approximately in the middle of said vertical axis.

29. The system recited in claim 26, wherein, in response to one of a move up and a move down command said active cell is reallocated to a new position, and a second cell becomes the active cell.

30. The system recited in claim 29, wherein prior to said command, information for a first set of programs associated with at least a first program grouping appears in cells located in at least a first row of said grid.

31. The system recited in claim 26, wherein, in response to a move right command, at least one of said plurality of cells is reallocated to a new position.

32. The system recited in claim 26, wherein said constant stable position of said point lies at a position along the horizontal axis corresponding to a first period of time after the start time of said grid.

33. The system recited in claim 32, wherein said first period of time is a positive integer multiple of a predefined time interval.

34. The system as recited in claim 33 wherein the predefined time interval is a multiple of 5 minutes.

35. The system recited in claim 22, wherein means of said visual indicating comprises a vertically oriented information line.

36. The system recited in claim 35, wherein said information line intersects a plurality of said cells.

37. The system recited in claim 36, wherein said information line comprises a visually distinguished segment for indicating said one active cell.

38. An electronic program guide system comprising: a grid displayed on a display area having horizontal and vertical axes, the grid including a plurality of cells, each cell containing information on a program; multiple means for visually indicating an active cell contained within said grid; wherein in prior to a user command of one of a move up, move down, move left, and move right, a first one of said multiple means is used to indicate a first active cell; wherein in response to a user command of one of a move up, move down, move left, and move right, a second one of said multiple means is used to indicate a second active cell; wherein said first means comprises a first graphical form; wherein said second means comprises a second graphical form; wherein said first graphical form is distinct from said second graphical form.

39. A method comprising: displaying on a display area having horizontal and vertical axes, the grid including a plurality of cells, each cell containing information on a program; visually indicating by multiple means an active cell contained within said grid; wherein in prior to a user command of one of a move up, move down, move left, and move right, a first one of said multiple means is used to indicate said active cell; wherein in response to a user command of one of a move up, move down, move left, and move right, a second one of said multiple means is used to indicate a second active cell; wherein said first means comprises a first graphical form; wherein said second means comprises a second graphical form; wherein said first graphical form is distinct from said second graphical form.

40. An article of manufacturing comprising: a machine accessible medium including data that, when accessed by a machine, causes the machine to perform operations comprising: displaying on a display area having horizontal and vertical axes, the grid including a plurality of cells, each cell containing information on a program; visually indicating by multiple means an active cell contained within said grid; wherein in prior to a user command of one of a move up, move down, move left, and move right, a first one of said multiple means is used to indicate said active cell; wherein in response to a user command of one of a move up, move down, move left, and move right, a second one of said multiple means is used to indicate a second active cell; wherein said first means comprises a first graphical form; wherein said second means comprises a second graphical form; wherein said first graphical form is distinct from said second graphical form.

41. A system comprising: a processor, and a memory coupled to the processor, the memory containing program code that, when executed by the processor, causes the processor to: display on a display area having horizontal and vertical axes a grid, the grid including a plurality of cells, each cell containing information on a program; visually indicate by multiple means an active cell contained within said grid; wherein in prior to a user command of one of a move up, move down, move left, and move right, a first one of said multiple means is used to indicate said active cell; wherein in response to a user command of one of a move up, move down, move left, and move right, a second one of said multiple means is used to indicate a second active cell; wherein said first means comprises a first graphical form; wherein said second means comprises a second graphical form; wherein said first graphical form is distinct from said second graphical form.

42. An electronic program guide system comprising: a grid displayed on a display area having horizontal and vertical axes, the grid including a plurality of cells, each cell containing information on a program; wherein the horizontal axis represents time; wherein whenever a user issues a first navigational command, said first navigational command being one of a move right and a move left, and the next navigational command issued by the user is a second command, said second command being one of a move right and a move left command, wherein said first command is for a movement in a different direction from said second command; the state of the grid following said second command is substantially the same as the state of the grid preceding said first command.

43. A method comprising: displaying on a display area having horizontal and vertical axes, the grid including a plurality of cells, each cell containing information on a program; wherein the horizontal axis represents time; wherein whenever a user issues a first navigational command, said first navigational command being one of a move right and a move left, and the next navigational command issued by the user is a second command, said second command being one of a move right and a move left command, wherein said first command is for a movement in a different direction from said second command; the state of the grid following said second command is substantially the same as the state of the grid preceding said first command.

44. An article of manufacturing comprising: a machine accessible medium including data that, when accessed by a machine, causes the machine to perform operations comprising: displaying on a display area having horizontal and vertical axes, the grid including a plurality of cells, each cell containing information on a program; wherein the horizontal axis represents time; wherein whenever a user issues a first navigational command, said first navigational command being one of a move right and a move left, and the next navigational command issued by the user is a second command, said second command being one of a move right and a move left command, wherein said first command is for a movement in a different direction from said second command; the state of the grid following said second command is substantially the same as the state of the grid preceding said first command.

45. A system comprising: a processor, and a memory coupled to the processor, the memory containing program code that, when executed by the processor, causes the processor to: display on a display area having horizontal and vertical axes a grid, the grid including a plurality of cells, each cell containing information on a program; wherein the horizontal axis represents time; wherein whenever a user issues a first navigational command, said first navigational command being one of a move right and a move left, and the next navigational command issued by the user is a second command, said second command being one of a move right and a move left command, wherein said first command is for a movement in a different direction from said second command; the state of the grid following said second command is substantially the same as the state of the grid preceding said first command.
